(19) United States
(12) Patent Application Publication
(10) Pub. No.: US 2022/0397708 A1
(43) Pub. Date: Dec. 15, 2022

(54) METHOD OF ETCHING SURFACE-RELIEF STRUCTURES

(71) Applicant: Meta Platforms Technologies, LLC, Menlo Park, CA (US)

(72) Inventor: Pasqual RIVERA, Woodinville, WA (US)

(21) Appl. No.: 17/832,215

(22) Filed: Jun. 3, 2022

Related U.S. Application Data
(60) Provisional application No. 63/209,322, filed on Jun. 10, 2021.

(51) Int. Cl. G02B 5/18

(52) U.S. Cl. CPC G02B 5/1857; G02B 2027/0178

(57) ABSTRACT

A method of fabricating a surface-relief structure in a material layer (e.g., including dielectric or semiconductor material) includes forming a mask layer on the material layer, implanting ions (e.g., using ion beam implantation or ion beam etching) into a plurality of regions of the material layer using the mask layer and an ion beam having a slant angle equal to or greater than 0° (e.g., greater than about 30° or about 45°) with respect to a surface normal direction of the material layer to increase the oxidation rate (or reduction rate) of the plurality of regions of the material layer, selectively oxidizing (or reducing) the plurality of regions of the material layer that include implanted ions, and selectively etching the oxidized or reduced materials in the plurality of regions of the material layer to form the surface-relief structure in the material layer.

### RELATED APPLICATIONS

This application claims the benefit of and priority to U.S. Provisional Application No. 63/209,322, filed Jun. 10, 2021, entitled “METHOD OF ETCHING SLANT GRATINGS,” which is assigned to the assignee hereof, and is herein incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using diffractive optical elements, such as surface-relief gratings or volume Bragg gratings. Light from the surrounding environment may pass through a see-through region of the waveguide and reach the user's eyes as well.

### SUMMARY

This disclosure relates generally to techniques for fabricating slanted structures, and more specifically, to techniques for making slanted structures (e.g., slanted gratings) with desired depths, slant angles, and/or duty cycles in various optical materials, such as silicon nitride, silicon carbide, TiOₓ, LiNbO₃, HfOₓ. TiSiOₓ, ZnSe, InGaAs, GaN, GaP, ZnS, gadolinium gallium garnet (GGG), organic materials, or inorganic metal oxides. In some embodiments, a slanted ion implementation technique may be used to modify the etch rate of the material layer such that the material layer may be selectively etched to remove the ion-implanted regions to form a slanted structure. In some embodiments, the ion implantation may cause a phase change of the material layer, for example, from the crystalline phase to amorphous phase, which may have a higher etch rate than the crystalline phase. In some embodiments, an oxidation process may be performed to further modify the ion implanted region to form oxides that may be more selectively etched (e.g., using chemically etching techniques, such as some dry or wet etching techniques). The slanted structures obtained by the processes and techniques disclosed herein can have a large slant angle, a high depth, a small duty cycle, and/or similar slant angles for the leading edge and trailing edge of a ridge. The oxidation and etching process may also remove regions that may have ions implanted therein and thus may have more defects, lower optical quality (e.g., higher absorption or scattering), and different refractive indices. Therefore, the slanted grating formed using techniques disclosed herein can have higher performance and lower loss. Various inventive embodiments are described herein, including devices, systems, methods, processes, materials, compositions, and the like.

According to certain embodiments, a method of fabricating a surface-relief structure in a material layer (e.g., including dielectric or semiconductor material) may include: forming a mask layer on the material layer; implanting ions into a plurality of regions of the material layer using the mask layer and an ion beam at a slant angle equal to or greater than 0°, where the slant angle is measured with respect to a surface normal direction of the material layer, and implanting the ions into the plurality of regions of the material layer increases an oxidation rate or a reduction rate of the plurality of regions of the material layer; selectively oxidizing or reducing the plurality of regions of the material layer that includes implanted ions; and selectively etching oxidized or reduced materials in the plurality of regions of the material layer to form the surface-relief structure in the material layer and reduce optical loss of the surface-relief structure caused by implanting the ions into the plurality of regions of the material layer.

In some embodiments, the method may also include performing the implanting, the selectively oxidizing, and the selectively etching repeatedly until a predetermined depth of the surface-relief structure is reached. The predetermined depth of the surface-relief structure may be greater than 200 nm, such as about 500 nm or greater. In some embodiments, the slant angle may be greater than about 30°, such as about 45° or larger. The implanted ions may include, for example, hydrogen ions, oxygen ions, helium ions, lithium ions, or a combination thereof. The material layer may include, for example, SiN, SiC, TiO₂, Al₂O₃, SiOₓN_{y}, LiNbO₃, HfOₓ, TiSiOₓ, TaOₓ, ZnSe, InGaAs, GaN, GaP, ZnS, gadolinium gallium garnet, spin on carbon, amorphous carbon, or diamond like carbon. The mask layer may include, for example, a photoresist, a metal, an intermetallic compound, poly-silicon, or a polymer. Implanting the ions into the plurality of regions of the material layer may cause a phase of the plurality of regions of the material layer to change to an amorphous phase. In some embodiments, the surface-relief structure includes a slanted surface-relief grating characterized by a grating period less than 1 μm and a duty cycle less than 30%. In some embodiments, the surface-relief structure includes a slanted surface-relief grating characterized by a width of a grating ridge less than 100 nm.

In some embodiments, implanting the ions into the plurality of regions of the material layer includes etching the material layer using the ion beam. In some embodiments, selectively etching the oxidized or reduced materials in the plurality of regions of the material layer includes a dry etching or wet etching process that has a higher etch rate for the oxide materials in the plurality of regions of the material layer than for materials in other regions of the material layer. In some embodiments, implanting the ions into the plurality of regions of the material layer includes rotating the material layer or the ion beam during the implanting to vary the slant angle of the ion beam with respect to the plurality of regions of the material layer. In some embodiments, implanting the ions into the plurality of regions of the material layer includes changing energy of the ions during the implanting to change an implantation depth in the plurality of regions of the material layer. In some embodiments, implanting the ions into the plurality of regions of the material layer includes implanting different amounts of ions into different regions of the plurality of regions using different ion currents for the ion beam, different implantation times, or both.

In some embodiments, selectively oxidizing or reducing the plurality of regions of the material layer includes implanted ions comprises performing oxidation and reduction alternately. In some embodiments, the method may also include removing the mask layer, and forming an overcoat layer on the surface-relief structure in the material layer. Forming the overcoat layer may include implanting ions at top surfaces of the surface-relief structure, oxidizing the surface-relief structure to form a deposition mask layer at the top surfaces of the surface-relief structure, and depositing the overcoating layer in grooves of the surface-relief structure using atomic layer deposition and the deposition mask layer.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates examples of propagations of display light and external light in an example of a waveguide display.

FIG. 6 illustrates an example of a slanted grating coupler in a waveguide display according to certain embodiments.

FIG. 7A illustrates an example of a waveguide-based near-eye display where display light for all fields of view is substantially uniformly output from different regions of a waveguide display.

FIG. 7B illustrates an example of a waveguide-based near-eye display where display light may be coupled out of a waveguide display at different angles in different regions of the waveguide display according to certain embodiments.

FIG. 8A illustrates an example of a slanted surface-relief grating with variable etch depths according to certain embodiments.

FIG. 8B illustrates an example of a slanted surface-relief grating with variable etch depths and variable duty cycles according to certain embodiments.

FIGS. 9A-9C illustrate an example of a process for fabricating a slanted surface-relief structure according to certain embodiments.

FIG. 10 illustrates an example of an ion beam etching system for fabricating a slanted surface-relief structure.

FIG. 11 illustrates an example of a chemically assisted ion beam etching (CAIBE) system for fabricating a slanted surface-relief structure.

FIG. 12 illustrates an example of a reactive ion beam etching (RIBE) system for fabricating a slanted surface-relief structure.

FIG. 13 illustrates an example of a chemically assisted reactive ion beam etching (CARIBE) system for fabricating a slanted surface-relief structure according to certain embodiments.

FIG. 14 illustrates another example of a CARIBE system for fabricating a slanted surface-relief structure according to certain embodiments.

FIGS. 15A-15E illustrate shadowing effect in slanted etching using hard etch masks.

FIG. 16A illustrates an example of a substrate in which a slanted structure may be formed using a mask according to certain embodiments.

FIG. 16B illustrates an example of a slanted ion implantation process according to certain embodiments.

FIG. 16C illustrates an example of a slanted surface-relief structure formed in a substrate after ion implantation and etch processes according to certain embodiments.

FIG. 17 shows ions implanted into a grating material layer after an ion etching process.

FIGS. 18A-18C show an example of a process of etching a slanted grating with improved optical quality.

FIG. 19 illustrates an example of a process for fabricating a slanted structure with a variable refractive index in a substrate according to certain embodiments.

FIG. 20 illustrates an example of a process for fabricating a slanted structure with a variable depth in a substrate according to certain embodiments.

FIG. 21 illustrates an example process for fabricating a slanted structure with a variable slant angle in a substrate according to certain embodiments.

FIG. 22 is a simplified flow chart illustrating an example method of fabricating a slanted structure according to certain embodiments.

FIG. 23 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to techniques for fabricating slanted micro- or nano-structures, and more specifically, to techniques for making slanted micro- or nano-structures (e.g., slanted gratings) with desired depths, slant angles, and/or duty cycles in various optical materials. Various inventive embodiments are described herein, including devices, systems, methods, processes, materials, compositions, and the like.

Slanted structures may be used in many optical devices for manipulating behavior of light. For example, slanted surface-relief gratings may be used in near-eye display systems to couple display light into or out of a waveguide. Using slanted surface-relief gratings in waveguide-based artificial reality display device can improve the field of view, increase the brightness efficiency, enable optical see-through, and reduce display artifacts (e.g., rainbow artifacts). A large slant angle (e.g., >45°), a high depth (e.g., greater than about 100 nm, 200 nm, 500 nm, or higher), a large duty cycle (or grating ridge width) range (e.g., from about 10% to about 90%), and/or a high refractive index contrast may be desired for improved performance (e.g., diffraction efficiencies) of the slanted gratings.

It may often be challenging to fabricate such slanted structures at a high production speed with a high fabrication accuracy, yield, and quality (e.g., with small line edge roughness, low line edge variations, low grating surface roughness, and without significant sub-surface damage from etching), using either nanoimprint techniques or etching techniques. For example, it may be difficult to fabricate such deep slanted structures with a large slant angle and a large range of duty cycles using imprint techniques without cracking or breaking at least some grating ridges of the mold, the stamp, or the imprinted deep slanted structures. To etch a deep surface-relief structure, a thick etch mask layer may be needed to withstand the high energy ions (e.g., hydrogen ions, oxygen ions, helium ions, lithium ions, or a combination thereof) over a long etching time period. However, in slanted etching where the etchants are incident on the etch mask layer and the material layer to be etched (e.g., a substrate under the etch mask layer) at a slant angle greater than 0° (e.g., 30° or larger, such as about 45° or larger) with respect to the surface normal of the etch mask layer and the material layer to be etched, the shadowing effect of the thick etch mask layer may cause the width of the grating ridges, and thus the duty cycle (which may be defined as the ratio between the width of the grating ridge and the grating period), of the slanted structure to be much larger than the line width (or the duty cycle) of the pattern on the etch mask layer. In general, the thicker the etch mask layer and the larger the slant angle, the higher the shadowing effect and thus the greater the increase in grating ridge width or duty cycle. For example, the duty cycle of a slanted structure etched using a thick etch mask with a duty cycle of 0.1 may be 0.4 or higher. The types of hard mask materials may be restricted by the specific chemistry of the surface, etch, and the subsequent integration flow steps.

In addition, during the ion beam etching process, ions may be implanted into the remaining grating material layer. In crystalline or other materials (polycrystalline or amorphous materials), these implanted ions may change certain physical and/or chemical properties of the grating materials, which may depend on the impurity type, concentration, and implantation depth of the implanted ions, and whether a post-implantation annealing step is performed at high temperatures (e.g., about 800° C., 1000° C., or even 1500° C. or higher). For example, the ion concentration and the implantation depth of the implanted regions may depend on the ion element, the etch angle, and ion energy of the ion beam and properties of the grating materials. In one example, the penetration of the ions due to the ion channeling effect may depend on the ion type and the angle of incidence with respect to the crystallographic axes (and crystal type). Thus, the ion implanted regions of the grating material layer may have modified physical properties, such as conductivity, optical loss, crystal phase and structure, effective refractive index, oxidation rate, and etch rate. Some of these changes in the local material properties are undesirable and can significantly degrade the performance of the slanted gratings. For example, due to the incorporation of implanted ions and changes (e.g., damages) to the crystalline structure, the refractive index of the implanted regions may be different from the refractive index of other regions of the grating material, and the optical loss of the grating material due to optical absorption, scattering, and/or Fresnel reflection may increase. Therefore, the performance (e.g., efficiency and image quality) of the waveguide-based artificial reality display device may be degraded.

In some waveguide display systems, it is desirable to using surface-relief gratings etched in materials having high refractive indices (e.g., n>1.9, such as about 1.9-2.0 or about 2.3), such as TiOₓ, LiNbO₃, HfOₓ. TiSiOₓ, SiC, ZnSe, InGaAs, GaN, GaP, ZnS, gadolinium gallium garnet (GGG), high-index glass (with n>1.8), and the like, such that a single surface-relief grating on a single waveguide can cover a large spectral range (e.g., the three primary colors) and a large (e.g., the full) field of view at a high efficiency. The single plate structure can also reduce weight, improve see-through quality, and reduce optical artifacts of the waveguide display systems. However, these high-refractive index materials may be difficult to etch (e.g., having low dry etch rates), and thus it can be challenging to fabricate deep surface-relief gratings with desired slant angles, grating depths, grating periods, and/or duty cycles, in such high index materials. For example, to achieve a certain etch depth in the high-refractive index materials, a thick etch mask layer may be needed, which may have a larger shadowing effect in slanted etching, and thus it may be difficult to fabricate slanted gratings with large slant angles, high depths, small duty cycles, and large refractive index contrast.

According to certain embodiments, the etch selectivity and other differences in the properties (e.g., oxidation rate) between the ion implanted regions (e.g., including hydrogen ions, oxygen ions, helium ions, lithium ions, or a combination thereof) and the pristine regions of the grating material layer may be used to improve the etch depth by subsequent high-selectivity etching of the ion implanted regions from the grating material layer. This selective etching can be achieved in several ways, depending on the type and concentration of the implanted ions and their impact on the implanted regions of the grating material layer. In one example, ions may be intentionally implanted in the grating material layer to cause a phase change in the grating material layer, for example, from crystalline to amorphous, and then the subsequent etch process may be tailored to preferentially etch the amorphous phase region.

In another example, certain types of ions may be implanted with a certain density to increase the oxidation or reduction rate of the affected grating material region compared to the pristine regions. Thus, oxidation of the entire device may cause rapid, selective oxidation of the ion implanted regions compared to the pristine regions. For example, high temperature annealing may be performed to oxidize (or reduce) the ion implanted regions. The process gas used for the high temperature annealing may include, for example, O₂, H₂/Ar, H₂O, and the like, such as forming gas, oxidative gas, steam anneal, thermal oxidation, and the like. Subsequent selective etching of the oxides may then result in more selective removal of the ion implanted regions. The etching of the ion implanted regions may be performed using ion beam etching, or using tailored wet etching processes. Techniques disclosed herein can achieve desired grating parameters, such as etch depth, slant angle, and duty cycle, while at the same time alleviating the undesirable properties of the ion implanted regions by removing the ion implanted regions. For example, techniques disclosed herein may achieve favorable surface preparation by removing highly absorbing surface offenders (e.g., adventitious carbon) and converting SiOC surface chemistries into SiO₂. In some embodiments, techniques disclosed herein may be implemented without using an ion beam etching (IBE) source. For example, in embodiments where the ion implantation was from some other plasma source or from intentional ion implanter, repeated ion implantation, oxidation, and removal processes may be performed to form the entire grating, without performing ion beam etching. In some embodiments, atomic layer deposition and atomic layer etching processes may be used to for binary or slanted gratings.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

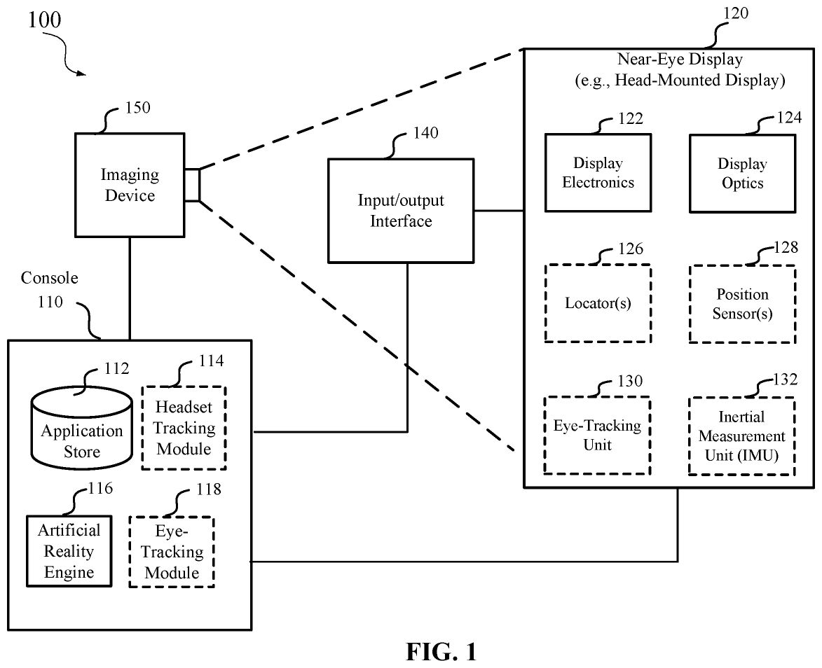

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

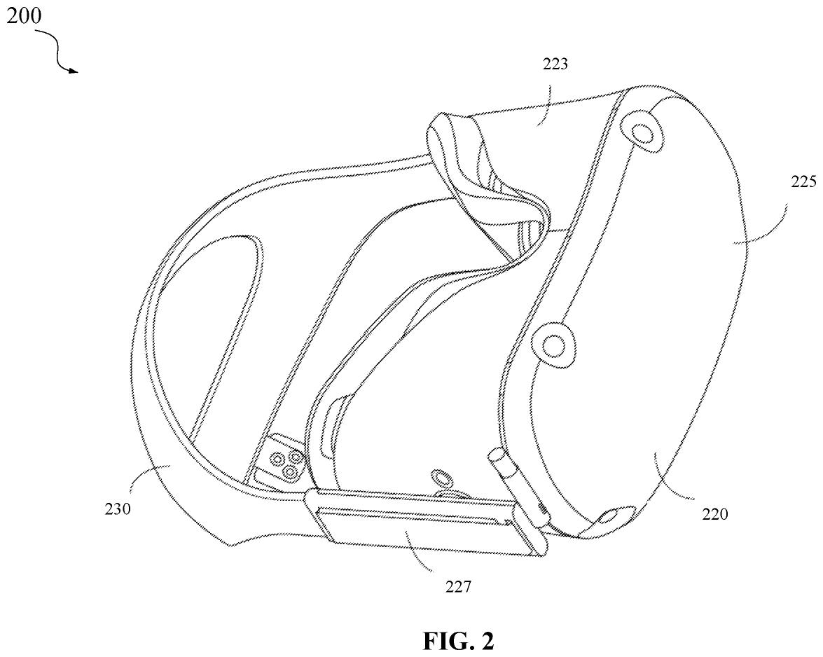

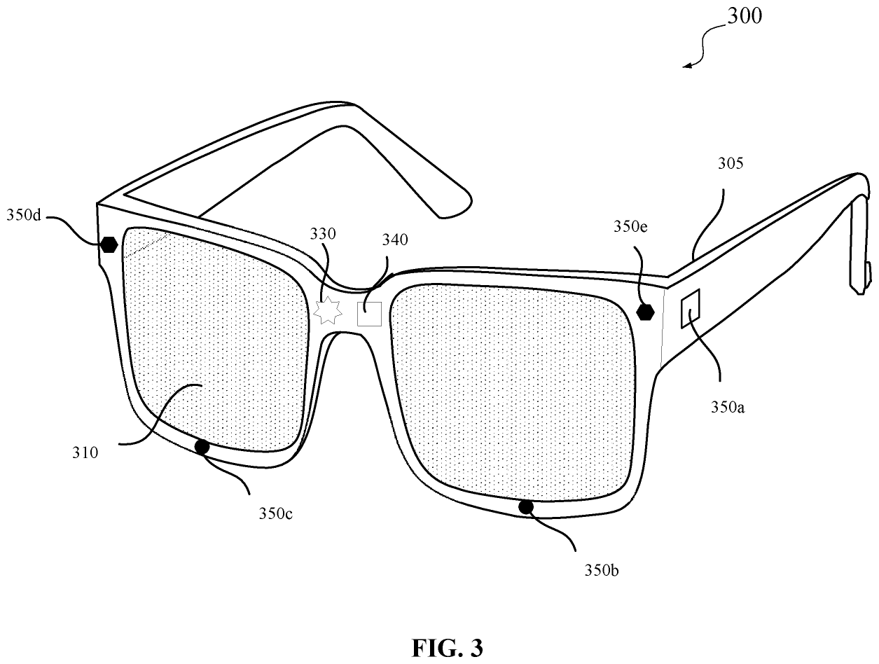

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

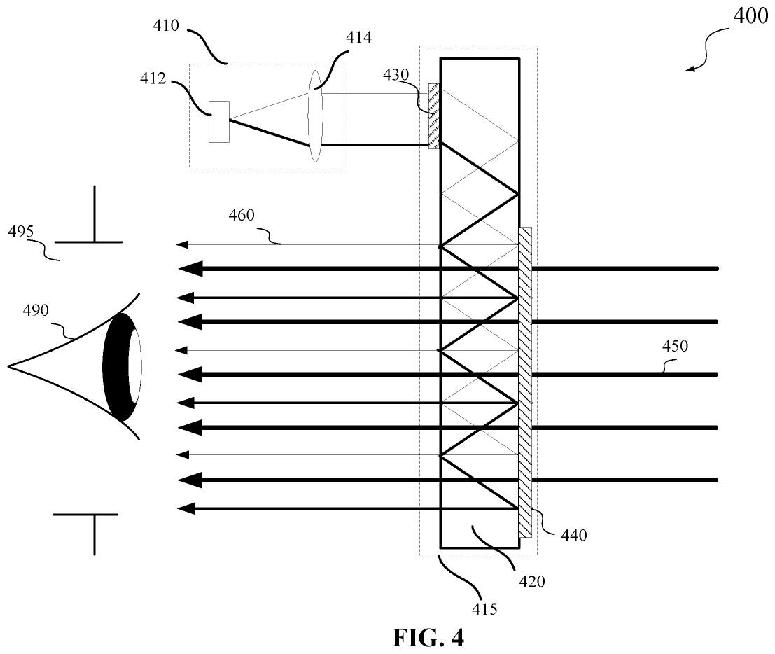

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit at least 50% of light in a first wavelength range and reflect at least 25% of light in a second wavelength range. For example, the first wavelength range may be visible light from about 400 nm to about 650 nm, and the second wavelength range may be in the infrared band, for example, from about 800 nm to about 1000 nm. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

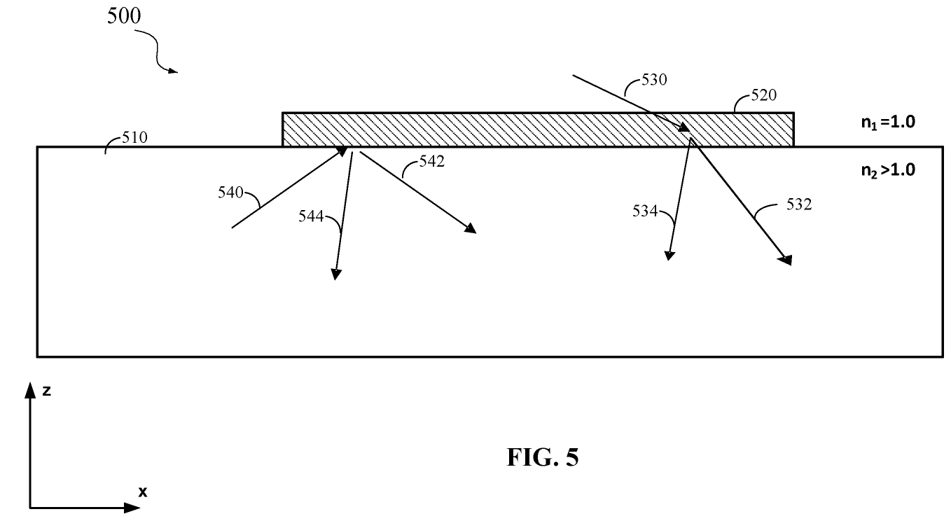

FIG. 5 illustrates propagations of display light 540 and external light 530 in an example waveguide display 500 including a waveguide 510 and a grating coupler 520. Waveguide 510 may be a flat or curved transparent substrate with a refractive index n₂ greater than the free space refractive index n₁ (e.g., 1.0). Grating coupler 520 may be, for example, a Bragg grating or a surface-relief grating.

Display light 540 may be coupled into waveguide 510 by, for example, input coupler 430 of FIG. 4 or other couplers (e.g., a prism or slanted surface) described above. Display light 540 may propagate within waveguide 510 through, for example, total internal reflection. When display light 540 reaches grating coupler 520, display light 540 may be diffracted by grating coupler 520 into, for example, a 0^{th} order diffraction (i.e., reflection) light 542 and a −1st order diffraction light 544. The 0^{th} order diffraction may propagate within waveguide 510, and may be reflected by the bottom surface of waveguide 510 towards grating coupler 520 at a different location. The −1st order diffraction light 544 may be coupled (e.g., refracted) out of waveguide 510 towards the user's eye, because a total internal reflection condition may not be met at the bottom surface of waveguide 510 due to the diffraction angle.

External light 530 may also be diffracted by grating coupler 520 into, for example, a 0^{th} order diffraction light 532 and a −1st order diffraction light 534. Both the 0^{th} order diffraction light 532 and the −1st order diffraction light 534 may be refracted out of waveguide 510 towards the user's eye. Thus, grating coupler 520 may act as an input coupler for coupling external light 530 into waveguide 510, and may also act as an output coupler for coupling display light 540 out of waveguide 510. As such, grating coupler 520 may act as a combiner for combining external light 530 and display light 540. In general, the diffraction efficiency of grating coupler 520 (e.g., a surface-relief grating coupler) for external light 530 (i.e., transmissive diffraction) and the diffraction efficiency of grating coupler 520 for display light 540 (i.e., reflective diffraction) may be similar or comparable.

In order to diffract light at a desired direction towards the user's eye and to achieve a desired diffraction efficiency for certain diffraction orders, grating coupler 520 may include a blazed or slanted grating, such as a slanted Bragg grating or surface-relief grating, where the grating ridges and grooves may be tilted relative to the surface normal of grating coupler 520 or waveguide 510.

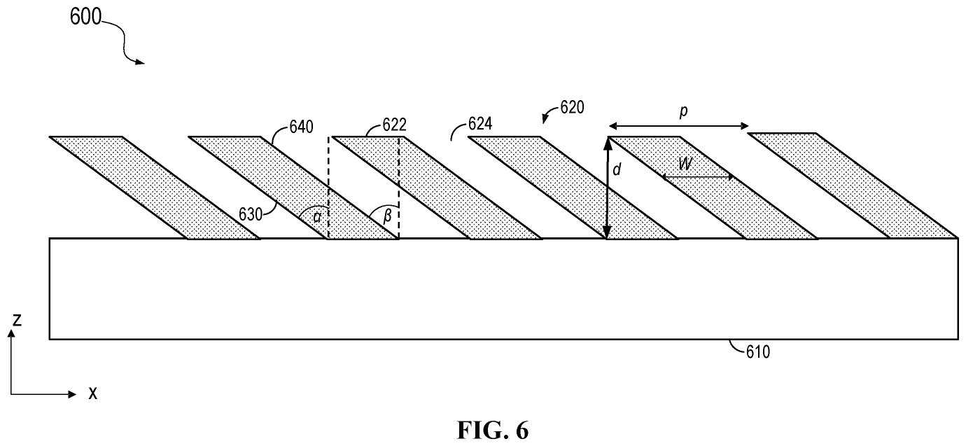

FIG. 6 illustrates an example of a slanted grating 620 in a waveguide display 600 according to certain embodiments. Slanted grating 620 may be an example of input coupler 430, output couplers 440, or grating coupler 520. Waveguide display 600 may include slanted grating 620 on a waveguide 610, such as substrate 420 or waveguide 510. Slanted grating 620 may act as a grating coupler for couple light into or out of waveguide 610. In some embodiments, slanted grating 620 may include a one-dimensional periodic structure with a period p. For example, slanted grating 620 may include a plurality of ridges 622 and grooves 624 between ridges 622. Each period of slanted grating 620 may include a ridge 622 and a groove 624, which may be an air gap or a region filled with a material with a refractive index n_{g2}. The ratio between the width d of a ridge 622 and the grating period p may be referred to as duty cycle. Slanted grating 620 may have a duty cycle ranging, for example, from about 10% to about 90% or greater. In some embodiments, the duty cycle may vary from period to period. In some embodiments, the period p of the slanted grating may vary from one area to another on slanted grating 620, or may vary from one period to another (i.e., chirped) on slanted grating 620.

Ridges 622 may be made of a material with a refractive index of n_{g1}, such as silicon containing materials (e.g., SiO₂, Si₃N₄, SiC, SiOₓN_{y}, or amorphous silicon), organic materials (e.g., spin on carbon (SOC) or amorphous carbon layer (ACL) or diamond like carbon (DLC)), or inorganic metal oxide layers (e.g., TiOₓ, AlOₓ, TaOₓ, HfOₓ, etc.). Each ridge 622 may include a leading edge 630 with a slant angel α and a trailing edge 640 with a slant angle β. In some embodiments, leading edge 630 and trailing edge 640 of each ridge 622 may be parallel to each other. In other words, slant angle α is approximately equal to slant angle β. In some embodiments, slant angle α may be different from slant angle β. In some embodiments, slant angle α may be approximately equal to slant angle β. For example, the difference between slant angle α and slant angle β may be less than 20%, 10%, 5%, 1%, or less. In some embodiments, slant angle α and slant angle β may range from, for example, about 30° or less to about 70% or larger.

In some implementations, grooves 624 between the ridges 622 may be over-coated or filled with a material having a refractive index n_{g2} higher or lower than the refractive index of the material of ridges 622. For example, in some embodiments, a high refractive index material, such as Hafnia, Titania, Tantalum oxide, Tungsten oxide, Zirconium oxide, Gallium sulfide, Gallium nitride, Gallium phosphide, silicon, and a high refractive index polymer, may be used to fill grooves 624. In some embodiments, a low refractive index material, such as silicon oxide, alumina, porous silica, or fluorinated low index monomer (or polymer), may be used to fill grooves 624. As a result, the difference between the refractive index of the ridges and the refractive index of the grooves may be greater than 0.1, 0.2, 0.3, 0.5, 1.0, or higher.

The user experience with an artificial reality system may depend on several optical characteristics of the artificial reality system, such as the field of view (FOV), image quality (e.g., resolution), size of the eye box of the system (to accommodate for eye and/or head movement), the distance of eye relief, optical bandwidth, and brightness of the displayed image. In general, the FOV and the eye box need to be as large as possible, the optical bandwidth needs to cover the visible band, and the brightness of the displayed image needs to be high enough (especially for optical see-through AR systems).

In a waveguide-based near-eye display, the output area of the display may be much larger than the size of the eyebox of the near-eye display system. The portion of light that may reach a user's eyes may depend on the ratio between the size of the eyebox and the output area of the display, which, in some cases, may be less than 10% for a certain eye relief and field of view. In order to achieve a desired brightness of the displayed image perceived by user's eyes, the display light from the projector or the light source may need to be increased significantly, which may increase the power consumption and cause some safety concerns.

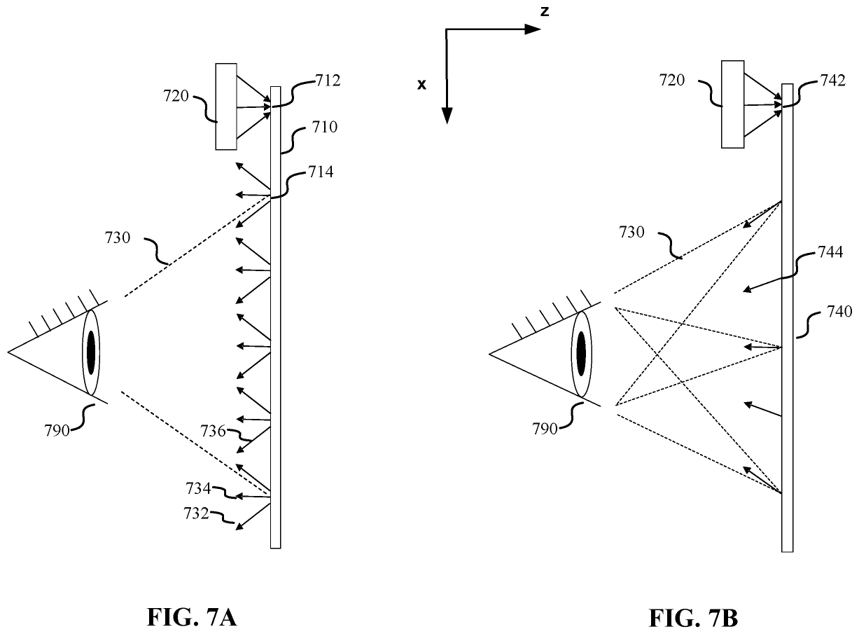

FIG. 7A illustrates an example of a waveguide-based near-eye display where display light for all fields of view is substantially uniformly output from different regions of a waveguide display 710. The near-eye display may include a projector 720 and waveguide display 710. Projector 720 may be similar to projector 410 and may include a light source or image source similar to light source or image source 412 and projector optics similar to projector optics 414. Waveguide display 710 may include a waveguide (e.g., a substrate), one or more input couplers 712, and one or more output couplers 714. Input couplers 712 may be configured to couple display light from different fields of view (or viewing angles) into the waveguide, and output couplers 714 may be configured to couple display light out of the waveguide. The input and output couplers may include, for example, slanted surface-relief gratings or volume Bragg gratings. In the example shown in FIG. 7, output coupler 714 may have similar grating parameters across the full region of the output coupler other than parameters that may be varied to adjust the coupling efficiency for more uniform output light. Thus, the display light may be partially coupled out of the waveguide at different regions of waveguide display 710 in a similar manner as shown in FIG. 7A, where display light from all fields of view of the near-eye display may be partially coupled out of the waveguide at any given region of waveguide display 710.

As also shown in FIG. 7A, the near-eye display system may have an eyebox at a certain eyebox position 790 and having a limited size and thus a limited field of view 730. As such, not all light coupled out of the waveguide in waveguide display 710 may reach the eyebox at eyebox position 790. For example, display light 732, 734, and 736 from waveguide display 710 may not reach the eyebox at eyebox position 790, and thus may not be received by the user's eyes, which may result in significant loss of the optical power from projector 720.

In certain embodiments, an optical coupler (e.g., a slanted surface-relief grating) for a waveguide-based display may include a grating coupler that includes multiple regions (or multiple multiplexed grating), where different regions of the grating coupler may have different angular selectivity characteristics (e.g., constructive interference conditions) for the incident display light such that, at any region of the waveguide-based display, diffraction light that would not eventually reach user's eyes may be suppressed (i.e., may not be diffracted by the grating coupler so as to be coupled into or out of the waveguide and thus may continue to propagate within the waveguide), while light that may eventually reach the user's eyes may be diffracted by the grating coupler and be coupled into or out of the waveguide.

FIG. 7B illustrates an example of a waveguide-based near-eye display where display light may be coupled out of a waveguide display 740 at different angles in different regions of the waveguide display according to certain embodiments. Waveguide display 740 may include a waveguide (e.g., a substrate), one or more input couplers 742, and one or more output couplers 744. Input couplers 742 may be configured to couple display light from different fields of view (e.g., viewing angles) into the waveguide, and output couplers 744 may be configured to couple display light out of the waveguide. The input and output couplers may include, for example, slanted surface-relief gratings or other types of gratings or reflectors. The output couplers may have different grating parameters and thus different angular selectivity characteristics at different regions of the output couplers. Thus, at each region of the output couplers, only display light that would propagate in a certain angular range towards the eyebox at eyebox position 790 of the near-eye display may be coupled out of the waveguide, while other display light may not meet the angular selectivity condition at the region and thus may not be coupled out of the waveguide. In some embodiments, the input couplers may also have different grating parameters and thus different angular selectivity characteristics at different regions of the input couplers, and thus, at each region of an input coupler, only display light from a respective field of view may be coupled into the waveguide. As a result, most of the display light coupled into the waveguide and propagating in the waveguide can be efficiently sent to the eyebox, thus improving the power efficiency of the waveguide-based near-eye display system.

The refractive index modulation of a slanted surface-relief grating, and other parameters of the slanted surface-relief grating, such as the grating period, the slant angle, the duty cycle, the depth, and the like, may be configured to selectively diffract incident light within a certain incident angular range (e.g., FOV) and/or a certain wavelength band at certain diffraction directions (e.g., within an angular range shown by field of view 730). For example, when the refractive index modulation is large (e.g., >0.2), a large angular bandwidth (e.g., >10°) may be achieved at the output couplers to provide a sufficiently large eyebox for the waveguide-based near-eye display system.

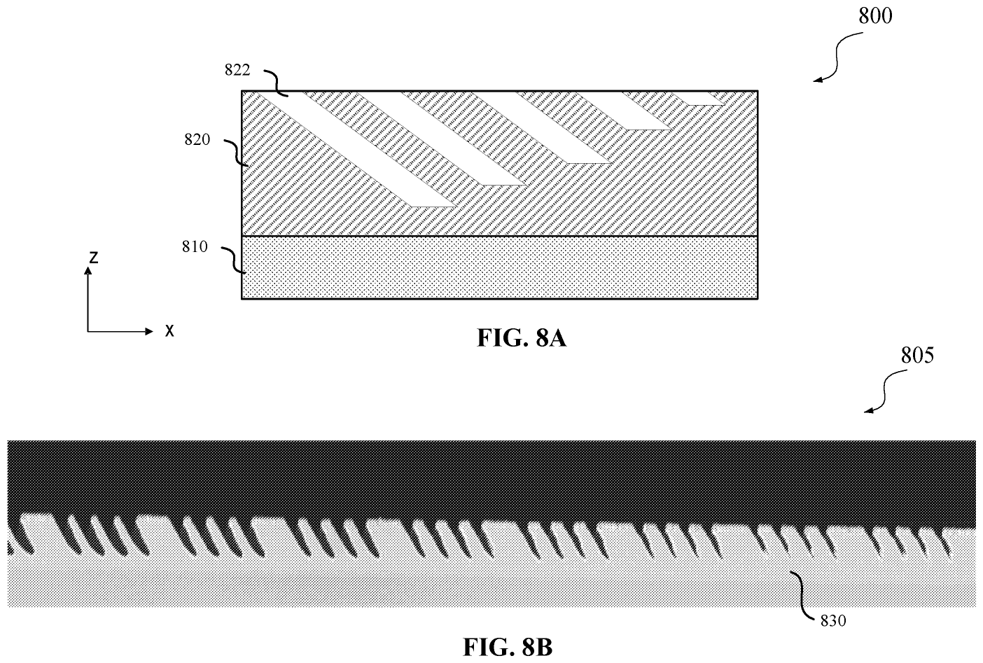

FIG. 8A illustrates an example of a slanted grating 800 with variable etch depths according to certain embodiments. Slanted grating 800 may include a substrate 810 (e.g., a glass substrate) and a grating layer 820 (e.g., a dielectric or polymer layer) formed on substrate 810. A plurality of grating grooves 822 may be etched or otherwise formed (e.g., imprinted) in grating layer 820. Grating grooves 822 may have non-uniform depths, widths, and/or separations. As such, slanted grating 800 may have variable grating periods, depths, and/or duty cycles.

FIG. 8B illustrates an example of a slanted grating 805 with variable etch depths and duty cycles according to certain embodiments. In the example shown in FIG. 8B, slanted grating 805 may be etched in a dielectric layer 830, which may have a refractive index, for example, between about 1.46 and about 2.4. As illustrated, slanted grating 805 may have different etch depths and duty cycles at different regions. The grating period may also be different at the different regions. As such, different regions of slanted grating 805 may have different desire diffraction characteristics as described above with respect to, for example, FIG. 7B.

The surface-relief gratings with parameters and configurations (e.g., duty cycles, depths, or refractive index modulations) varying over the regions of the gratings described above and other surface-relief gratings (e.g., gratings used for eye-tracking) may be fabricated using many different nanofabrication techniques. The nanofabrication techniques generally include a patterning process and a post-patterning (e.g., over-coating) process. The patterning process may be used to form slanted ridges or grooves of the slanted grating. There may be many different nanofabrication techniques for forming the slanted ridges. For example, in some implementations, the slanted grating may be fabricated using lithography techniques including slanted etching. In some implementations, the slanted grating may be fabricated using nanoimprint lithography (NIL) molding techniques, where a master mold including slanted structures may be fabricated using, for example, slanted etching techniques, and may then be used to mold slanted gratings or different generations of soft stamps for nanoimprinting. The post-patterning process may be used to over-coat the slanted ridges and/or to fill the gaps between the slanted ridges with a material having a different refractive index than the slanted ridges. The post-patterning process (e.g., overcoating and planarization) may be independent from the patterning process. Thus, a same post-patterning process may be used on slanted gratings fabricated using any patterning technique.

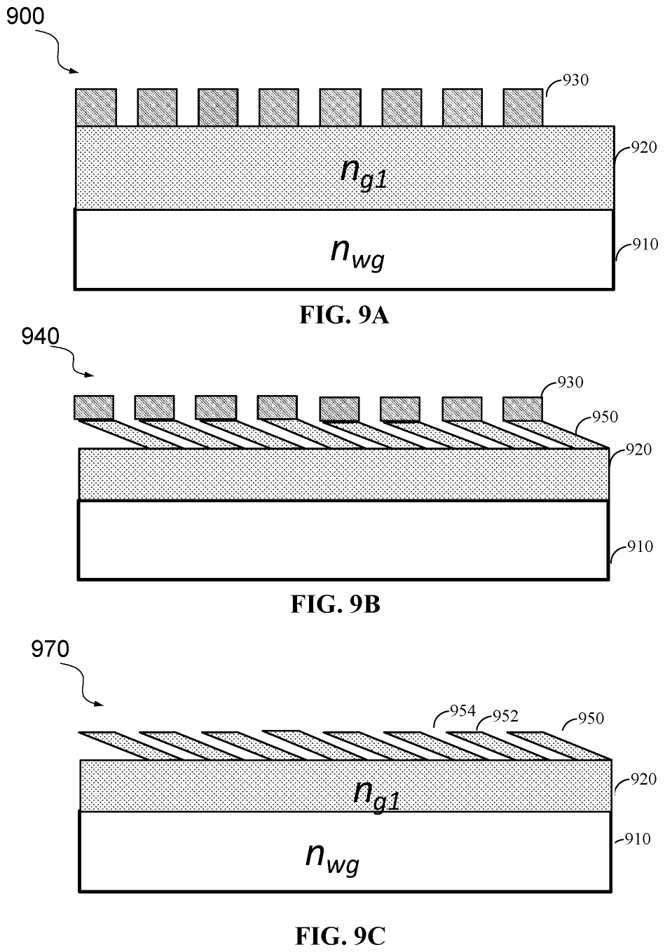

FIGS. 9A-9C illustrate an example of a simplified process for fabricating a slanted surface-relief grating by slanted etching according to certain embodiments. FIG. 9A shows a structure 900 after a lithography process, such as a photolithography process. Structure 900 may include a substrate 910 that may be used as the waveguide of a waveguide display described above, such as a glass or quartz substrate. Structure 900 may also include a layer of grating material 920, such as Si₃N₄, SiO₂, TiOₓ, LiNbO₃, HfOₓ. TiSiOₓ, AlOₓ, TaOₓ, SiC, ZnSe, InGaAs, GaP, or any other grating materials described herein. Substrate 910 may have a refractive index n_{wg}, and the layer of grating material 920 may have a refractive index n_{g1}. In some embodiments, the layer of grating material 920 may be a part of substrate 910. A mask layer 930 with a desired pattern may be formed on the layer of grating material 920. Mask layer 930 may include, for example, a photoresist material, a metal (e.g., copper, chrome, titanium, aluminum, or molybdenum), an intermetallic compound (e.g., MoSiON), or a polymer. Mask layer 930 may be formed by, for example, the optical projection or electron beam lithography process, ML process, or multi-beam interference process.

FIG. 9B shows a structure 940 after a slanted etching process, such as a dry etching process (e.g., reactive ion etching (RIE), inductively coupled plasma (ICP), deep silicon etching (DSE), ion beam etching (IBE), or variations of IBE). The slanted etching process may include one or more sub-steps. The slanted etching may be performed by, for example, rotating structure 900 and etching the layer of grating material 920 by the etching beam based on the desired slant angle. After the etching, a slanted grating 950 may be formed in the layer of grating material 920.

FIG. 9C shows a structure 970 after mask layer 930 is removed. Structure 970 may include substrate 910, the layer of grating material 920, and slanted grating 950. Slanted grating 950 may include a plurality of ridges 952 and grooves 954. Techniques such as plasma or wet etching may be used to strip mask layer 930 with appropriate chemistry. In some implementations, mask layer 930 may not be removed and may be used as part of the slanted grating.

Subsequently, in some implementations, the post-patterning (e.g., over-coating) process may be performed to over-coat slanted grating 950 with a material having a refractive index higher or lower than the material of ridges 952. For example, as described above, in some embodiments, a high refractive index material, such as Hafnia, Titania, Tungsten oxide, Zirconium oxide, Gallium sulfide, Gallium nitride, Gallium phosphide, silicon, and a high refractive index polymer, may be used for the over-coating. In some embodiments, a low refractive index material, such as silicon oxide, alumina, porous silica, or fluorinated low index monomer (or polymer), may be used for the over-coating. As a result, the difference between the refractive index of the ridges and the refractive index of the grooves may be greater than 0.1, 0.2, 0.3, 0.5, 1.0, or higher.

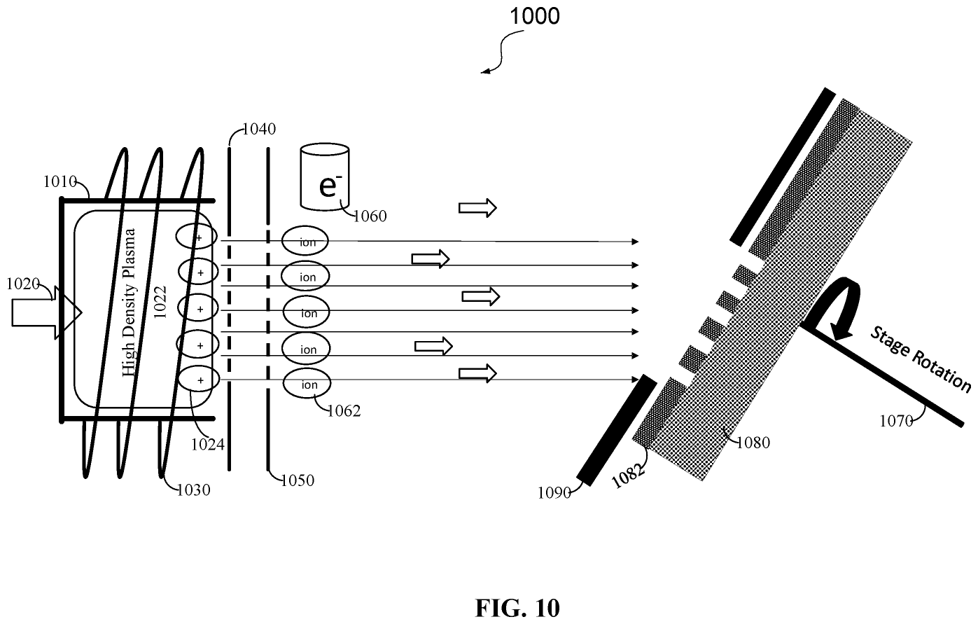

FIG. 10 illustrates an example of an ion beam etching (IBE) system 1000 for fabricating a slanted surface-relief structure. Ion beam etching is one process enabler in surface relief grating fabrication. Ion beam etching generally uses a highly collimated and highly directional ion beam to physically mill materials from a substrate mounted on a rotation stage with an adjustable rotation angle.

IBE system 1000 may include an ion source generator 1010. Ion source generator 1010 may include an inert gas inlet 1020 for receiving an inert gas, such as an Argon gas, into a chamber of ion source generator 1010. A plasma may be generated in ion source generator 1010 via an RF inductively coupled plasma (ICP) generator 1030, where highly energetic electrons may ionize neutrals of the injected inert gas (e.g., Ar) through collisions with the neutrals. A high density plasma 1022 may be generated within ion source generator 1010 by the impact ionization. High density plasma 1022 may be considered as a sea of neutrals with positive ions 1024 and negative electrons in charge equilibrium.

IBE system 1000 may also include one or more aligned collimator grids for extracting a collimated ion beam 1062 from high density plasma 1022 formed within ion source generator 1010. The aligned collimator grids may be implemented in various ways. For example, as shown in FIG. 10, the aligned collimator grids may include an extraction grid 1040 that may contact high density plasma 1022 and control its potential, and an acceleration grid 1050 that may be driven by an adjustable negative high voltage supply for accelerating the extracted ions. A beam neutralizer 1060 may be disposed near the aligned collimator grids and may emit an electron beam into collimated ion beam 1062 to achieve a net neutral charge flux associated with collimated ion beam 1062 in order to prevent the buildup of positive charges on the structure to be etched.

The highly directional collimated ion beam 1062 may physically mill materials from a material layer 1080 to be etched, such as, for example, a semiconductor wafer, a glass substrate, a Si3N4 material layer, a titanium oxide layer, an alumina layer, etc. Material layer 1080 may be partially covered by a mask 1082, which may be formed on material layer 1080 by, for example, a photolithography process. Mask 1082 may include, for example, a photoresist material, a metal (e.g., copper, chrome, aluminum, or molybdenum), an intermetallic compound (e.g., MoSi₂), or a polymer. In some embodiments, a shutter 1090 (or blade) may be used to control the etch time and/or the etch region. Material layer 1080 may be mounted on a rotation stage 1070 that can be rotated to modify the angle of material layer 1080 with respect to the highly directional collimated ion beam 1062. The ability to modify the angle of material layer 1080 may allow for the creation of tailored sidewall profiles with minimal sputtered redeposition on mask 1082. Since the IBE mechanism is purely physical, the etch rate may not be as fast as desired. In addition, the energetic ions may cause stoichiometric damage to the material layer and introduce defects, and thus may lead to degraded performance of the etched slanted structure.

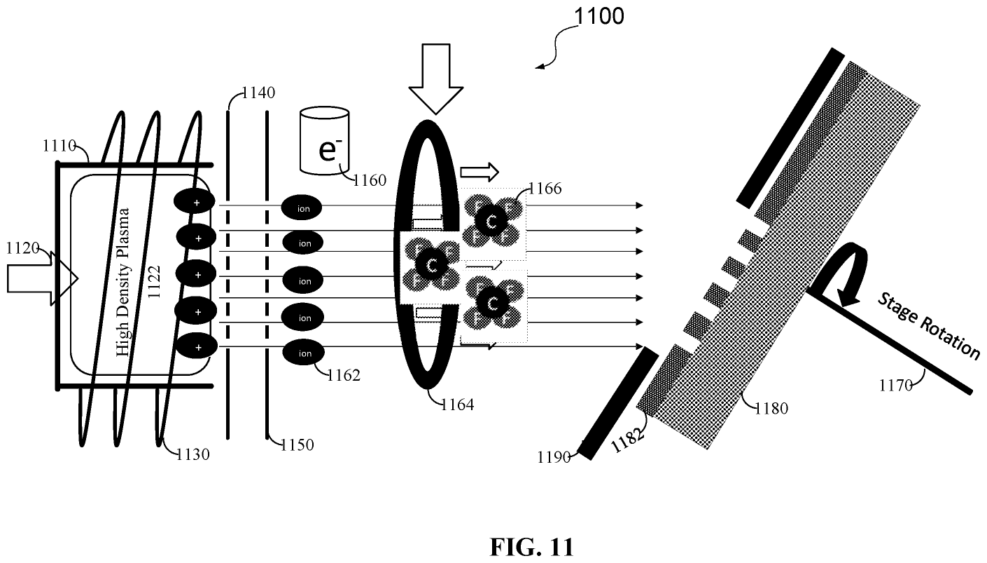

FIG. 11 illustrates an example of a chemically assisted ion beam etching (CAIBE) system 1100 for fabricating a slanted surface-relief structure. In the chemically assisted ion beam etching, reactive species, such as a reactive gas (e.g., CF₄, CHF₃, N₂, O₂, SF₆, Cl₂, BCl₃, HBr, etc.) may be introduced into the process independent of the ion beam. Thus, the material layer to be etched may be etched both physically and chemically.

As IBE system 1000, CAIBE system 1100 may include an ion source generator 1110. Ion source generator 1110 may be similar to ion source generator 1010 described above with respect to FIG. 10. Ion source generator 1110 may include an inert gas inlet 1120 for receiving an inert gas, such as an Argon gas, into a chamber of ion source generator 1110. A plasma may be generated in ion source generator 1110 via an RF inductively coupled plasma (ICP) generator 1130. A high density plasma 1122 may be generated within ion source generator 1110 by impact ionization. One or more aligned collimator grids may be used to extract a collimated ion beam 1162 from high density plasma 1122. For example, as shown in FIG. 11, the aligned collimator grids may include an extraction grid 1140 that may contact high density plasma 1122 and control its potential, and an acceleration grid 1150 that may be driven by an adjustable negative high voltage supply for accelerating the extracted ions. A beam neutralizer 1160 may be disposed near the aligned collimator grids and may emit an electron beam into collimated ion beam 1162 to achieve a net neutral charge flux associated with collimated ion beam 1162 in order to prevent the buildup of positive charges on the structure to be etched.

In addition, an reactive gas 1166 (e.g., CF₄, CHF₃, N₂, O₂, SF₆, Cl₂, BCl₃, HBr, etc.) may be injected onto a material layer 1180 to be etched using a gas ring 1164. In general, reactive gas 1166 may be injected at a location close to material layer 1180. Reactive gas and collimated ion beam 1162 may reach areas of material layer 1180 uncovered by a mask 1182, and both physically (as in IBE) and chemically etch the uncovered area. For example, a glass substrate may be chemically etched by a reactive gas CF₄ according to:

SiO₂+CF₄→SiF₄+CO₂.

SiF₄ and CO₂ are volatile materials that may be easily removed. As IBE system 1000, CAIBE system 1100 may include a shutter 1190 (or blade) for controlling the etch time and/or the etch region. Material layer 1180 may be mounted on a rotation stage 1170 that can be rotated to modify the angle of material layer 1180 with respect to the highly directional collimated ion beam 1162. For certain materials, an CAIBE system may offer additional control of etch anisotropy, sputter redeposition, and etch rate over an IBE system.

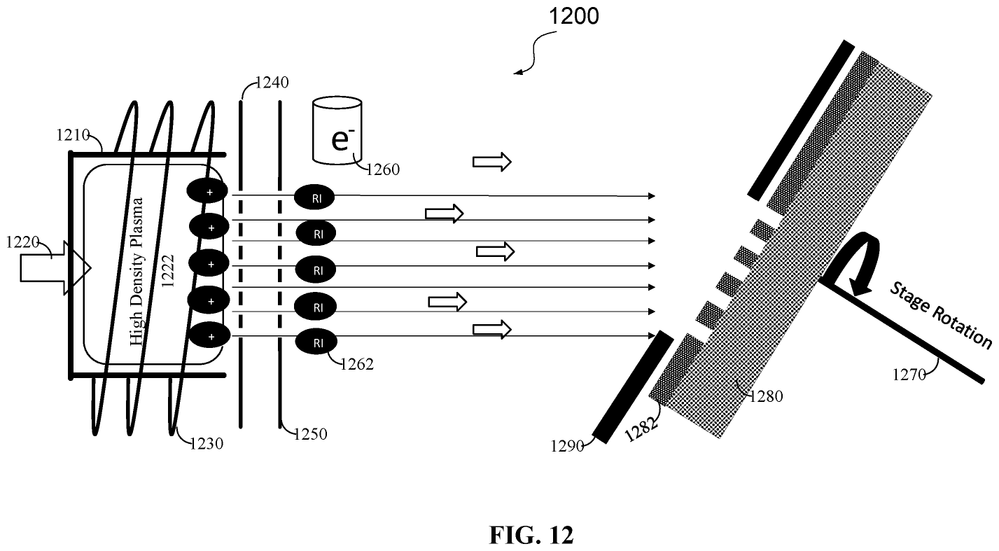

FIG. 12 illustrates an example of a reactive ion beam etching (RIBE) system 1200 for fabricating a slanted surface-relief structure. Reactive ion beam etching system 1200 may be similar to IBE system 1000, except that a reactive gas (e.g., CF₄, CHF₃, N₂, O₂, SF₆, Cl₂, BCl₃, HBr, etc.) may also be injected into the ion source generator to form a reactive ion beam that can both physically and chemically etch the material layer to be etched.

RIBE system 1200 may be similar to IBE system 1000, and may include an ion source generator 1210 for generating a high density plasma 1222. Ion source generator 1210 may include an gas inlet 1220 for receiving a reactive gas (e.g., CF₄, CHF₃, N₂, O₂, SF₆, Cl₂, BCl₃, or HBr, etc.) and, in some cases, an inert gas (e.g., Argon gas, Helium gas, or Neon gas) into a chamber of ion source generator 1210. High density plasma 1222 may be generated by impact ionization in ion source generator 1210 via an RF inductively coupled plasma (ICP) generator 1230. One or more aligned collimator grids may be used to extract a collimated reactive ion beam 1262 from high density plasma 1222. For example, as shown in FIG. 12, the aligned collimator grids may include an extraction grid 1240 that may contact high density plasma 1222 and control its potential, and an acceleration grid 1250 that may be driven by an adjustable negative high voltage supply for accelerating the extracted reactive ions. A beam neutralizer 1260 may be disposed near the aligned collimator grids and may emit an electron beam into collimated reactive ion beam 1262 to achieve a net neutral charge flux associated with collimated reactive ion beam 1262 in order to prevent the buildup of positive charges on the structure to be etched.

Collimated reactive ion beam 1262 may reach areas of a material layer 1280 uncovered by a mask 1282, and physically and chemically etched the uncovered area. As IBE system 1000 and CAIBE system 1100, RIBE system 1200 may also include a shutter 1290 (or blade) for controlling the etch time and/or the etch region. Material layer 1280 may be mounted on a rotation stage 1270 that can be rotated to modify the angle of material layer 1280 with respect to the highly directional collimated reactive ion beam 1262. For certain materials, an RIBE system may offer additional control of etch anisotropy, sputter redeposition, and etch rate over an IBE system.

For many materials (e.g., silicon nitride, organic materials, or inorganic metal oxides) and/or certain desired slanted features (e.g., grating ridge with substantially equal leading edge and trailing edge), these known etching processes, such as the IBE process, RIBE process, and CAIBE process, may not be used to reliably fabricate the slanted structures. One reason is that these processes may not provide appropriate combinations of reactants and/or process parameters for etching the desired slanted structures on the desired materials. According to certain embodiments, a chemically assisted reactive ion beam etch (CARIBE) process can be used to fabricate slanted surface-relief structures on various materials. The CARIBE process disclosed herein may provide more effective control of radicals and ions by providing appropriate chemical components in the ion source and the gas ring, and thus may enable improved profile and mask selectivity for materials requiring a higher amount of chemical component for etching and may also help in increasing the etch stop margin. Using the CARIBE process, the features of the slanted structure can be more accurately fabricated on various materials, including materials that may need a higher number of chemical components. In some embodiments, the process described herein may be used to fabricate a grating on an object that controls the behavior of light as the light reflects, refracts, and/or diffracts due to the interactions with the gratings and/or the interferences between light that interacts with the gratings. In some embodiments, the grating may be slanted and the object may be an optical element, such as a waveguide for waveguide display.

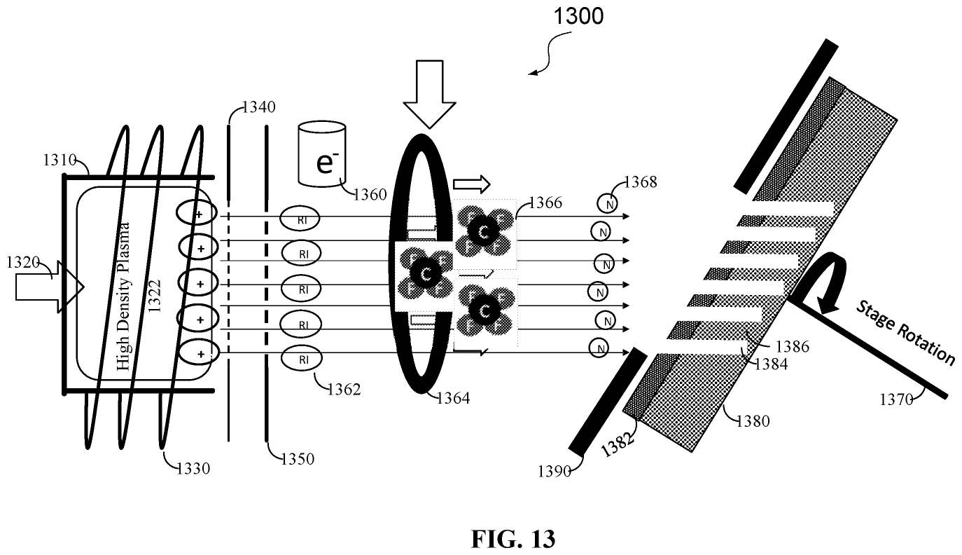

FIG. 13 illustrates an example of a chemically assisted reactive ion beam etching (CARIBE) system 1300 for fabricating a slanted surface-relief structure according to certain embodiments. CARIBE system 1300 may include a reactive ion source generator 1310. Reactive ion source generator 1310 may include an gas inlet 1320 for receiving a reactive gas (e.g., CF₄, CHF₃, N₂, O₂, SF₆, H₂, Cl₂, BCl₃, HBr, etc.) and, in some cases, an inert gas (e.g., Argon gas) into a chamber of reactive ion source generator 1310. A high density plasma 1322 may be generated by impact ionization in reactive ion source generator 1310 via an RF inductively coupled plasma (ICP) generator 1330. One or more aligned collimator grids may be used to extract a collimated reactive ion beam 1362 from high density plasma 1322. For example, as shown in FIG. 13, the aligned collimator grids may include an extraction grid 1340 that may contact high density plasma 1322 and control its potential, and an acceleration grid 1350 that may be driven by an adjustable negative high voltage supply for accelerating the extracted reactive ions. A beam neutralizer 1360 may be disposed near the aligned collimator grids and may emit an electron beam into collimated reactive ion beam 1362 to achieve a net neutral charge flux associated with collimated reactive ion beam 1362 in order to prevent the buildup of positive charges on the structure to be etched.

In addition, CARIBE system 1300 may include a gas ring 1364 for injecting an reactive gas 1366 (e.g., CF₄, NF₃, CHF₃, N₂, O₂, SF₆, Cl₂, BCl₃, HBr, etc.) onto the material layer to be etched at a location close to the material layer. Collimated reactive ion beam 1362 (or neutrals 1368 after neutralization) and reactive gas 1366 may reach areas of a material layer 1380 uncovered by a mask 1382, and may physically and chemically etched the uncovered area due to physical milling and chemical reactions. For example, a Si₃N₄ layer may be chemically etched by a reactive gas CF₄ according to:

Si₃N₄+4CF₃+F→NF₃+FCN_{Z}+3SiF₄,

where the NF₃, FCN_{Z}, and SiF₄ may be volatile material and can be relatively easily removed to form the slanted structures in the Si₃N₄ layer. The neutral to ion ratio in the beam that reaches material layer 1380 in the CARIBE process may be higher than that in the RIBE or CAIBE process.

CARIBE system 1300 may include a shutter 1390 (or blade) for controlling the etch time and/or the etch region. Material layer 1380 may be mounted on a rotation stage 1370 that can be rotated to modify the angle of material layer 1380 with respect to the highly directional collimated reactive ion beam 1362. As a result, a slanted structure including a plurality of grooves 1384 and a plurality of ridges 1386 may be formed in material layer 1380. The width and the slant angle of ridges 1386 may be more precisely controlled, compare with the IBE, RIBE, or CAIBE process.

In general, the ion source generator used in semiconductor etching, such as an inductive coupled plasma (ICP) chamber, may include an internal cavity layer made with quartz. When certain gases, such as a hydrogen gas, is added in the ion source generator, certain ions, such as hydrogen ions, generated in the chamber may enter and/or react with the quartz layer and change the physical and/or chemical properties of the quartz layer, which may cause damage to the quartz layer. According to certain embodiments, the quartz layer in the ion source generator may be replaced with oxide materials, such as aluminum oxide (Al₂O₃) or Y₂O₃, in order to use in select etching processes, such as hydrogen-based or hydrogen-assisted ion beam etching described herein.

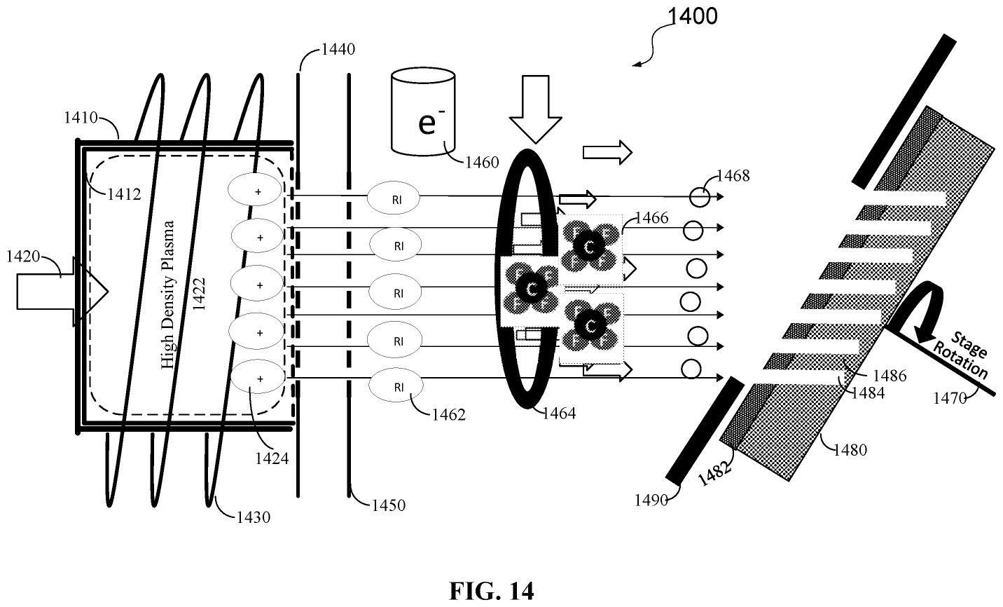

FIG. 14 illustrates another example of a chemically assisted reactive ion beam etching (CARIBE) system 1400 for fabricating a slanted surface-relief structure according to certain embodiments. CARIBE system 1400 may include an ion source generator 1410, such as a reactive ion source generator, which may be similar to ion source generator 1010, 1110, 1210, or 1310. Ion source generator 1410 may include an inert gas inlet 1420 for receiving gases, such as certain combinations of H₂, N₂, NF₃, NH₃, CH₄, CHF₃, CF₄, CH₂F₂, CH₃F, C₄F₈, C₄F₆, C₂F₆, C₂F₈, SF₆, CLF₃, N₂O, O₂, SO₂, COS, He, Cl₂, HBr, BCl₃, or the like, into a chamber of ion source generator 1410. A plasma may be generated in ion source generator 1410 via an RF inductively coupled plasma (ICP) generator 1430, where highly energetic electrons may ionize neutrals of the injected inert gases (e.g., a hydrogen-containing or hydrogen-based gas species, or a nitrogen-containing or nitrogen-based gas species) through collisions with the neutrals. A high density plasma 1422 may be generated within ion source generator 1410 by the impact ionization. High density plasma 1422 may include positive ions 1424 and negative electrons in charge equilibrium.

The surface layer 1412 of the internal cavity of ion source generator 1410 may include a layer of an oxide material, such as aluminum oxide (Al₂O₃) or yttrium oxide (Y₂O₃), such that the hydrogen ions generated in the chamber may not enter or may not react with surface layer 1412 and change the physical and/or chemical properties of surface layer 1412. Thus, surface layer 1412 may not be damaged by the ions generated inside the cavity.

CARIBE system 1400 may also include one or more aligned collimator grids for extracting a collimated reactive ion beam 1462 from high density plasma 1422 formed within ion source generator 1410. The aligned collimator grids may be implemented in various ways. For example, as shown in FIG. 14, the aligned collimator grids may include an extraction grid 1440 that may control the potential of high density plasma 1422, and an acceleration grid 1450 that may be driven by an adjustable (negative or positive) high voltage supply for accelerating the extracted ions. A beam neutralizer 1460 may optionally be positioned near the aligned collimator grids. Beam neutralizer 1460 may emit an electron beam into collimated reactive ion beam 1462 to achieve a net neutral charge flux associated with collimated reactive ion beam 1462 in order to prevent the buildup of positive charges on the structure to be etched.

CARIBE system 1400 may further include a gas ring 1464 for injecting an reactive gas 1466 (e.g., CF₄, NF₃, SF₆, CHF₃, N₂, O₂, Cl₂, HBr, BCl₃, etc.) onto the material layer to be etched at a location close to the material layer. Collimated reactive ion beam 1462 (and/or neutrals 1468 after neutralization) and reactive gas 1466 may reach areas of a material layer 1480 uncovered by a mask 1482, and may physically and chemically etched the uncovered area due to physical milling and chemical reactions. The neutral to ion ratio in the beam that reaches material layer 1480 in the CARIBE process may be higher than that in the RIBE or CAIBE process.

CARIBE system 1400 may include a shutter 1490 (or blade) for controlling the etch time and/or the etch region. Material layer 1480 may be mounted on a rotation stage 1470 that can be rotated to modify the angle of material layer 1480 with respect to the highly directional collimated reactive ion beam 1462. As a result, a slanted structure including a plurality of grooves 1484 and a plurality of ridges 1486 may be formed in material layer 1480. The width and the slant angle of ridges 1486 may be more precisely controlled, compare with the IBE, RIBE, or CAIBE process.

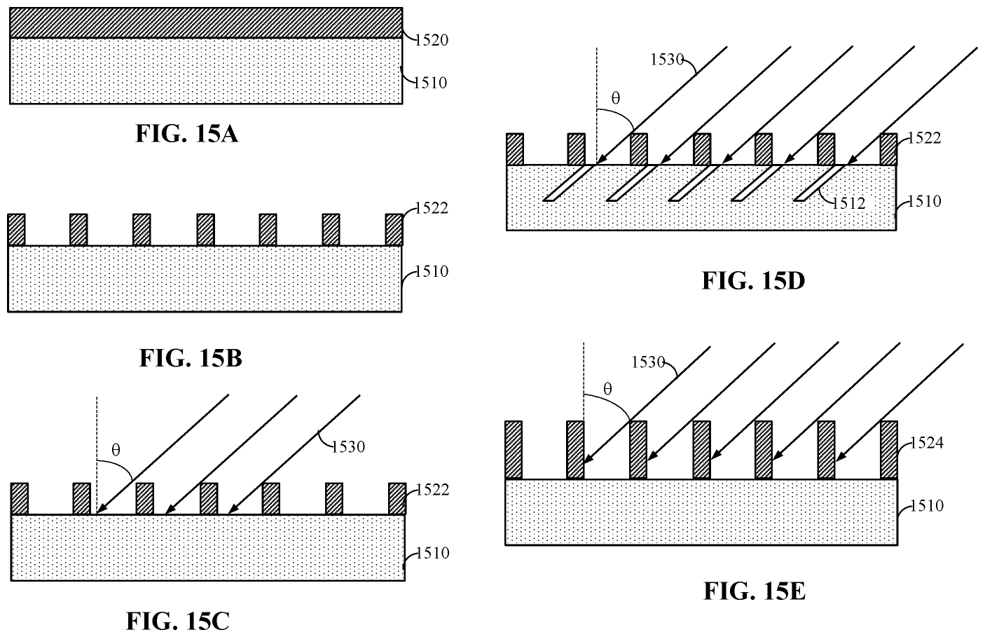

FIGS. 15A-15E illustrate shadowing effect in slanted etching using hard etch mask. As described above, to selectively couple display light and/or ambient light into and/or out of the waveguide and into user's eyes, improve the field of view, increase brightness or power efficiency, reduce display artifacts (e.g., rainbow artifacts), and/or improve other performances of a waveguide display, a slanted surface-relief grating having a large range of grating duty cycles (e.g., from about 0.1 to about 0.9), large slant angles (e.g., greater than 30°, 45°, 60°, or larger), high depths (e.g., greater than 100 nm, such as 200 nm, 300 nm, 400 nm, 500 nm, or higher), and subwavelength grating periods for visible light (e.g., less than about 700 nm, 600 nm, 500 nm, 400 nm, 300 nm, 200 nm, or smaller) may be desired. As also described above, it may be challenging to etch such slanted structures at a high production speed with a high fabrication accuracy and yield.

FIG. 15A show a grating material layer 1510 and an etch mask layer 1520 deposited on grating material layer 1510. AS described above, grating material layer 1510 may include, for example, glass, quartz, plastic, polymer, poly(methyl methacrylate) (PMMA), crystal, SiN, SiC, ceramic, TiOₓ, LiNbO₃, HfOₓ. TiSiOₓ, ZnSe, InGaAs, GaN, GaP, and the like. Etch mask layer 1520 may include, for example, a photoresist material, a metal (e.g., copper, chrome, aluminum, or molybdenum), an intermetallic compound (e.g., MoSi₂), poly-silicon, or a polymer. The material of etch mask layer 1520 and the thickness of etch mask layer 1520 may be selected based on, for example, the etching recipe, the etch selectivity, and the desired etch depth. For example, to etch a deep surface-relief structure using, for example, ion beams or plasma, the energy and dosage of the ions may need to be high and the etch time may be long. As such, a thick etch mask layer may be needed in order to withstand the high energy ions over a long etching time period.

FIG. 15B shows that etch mask layer 1520 may be patterned, for example, using a lithography process, to form etch masks 1522. The pattern of etch masks 1522 may correspond to the pattern of the grating ridges of the desired slanted surface-relief grating, where each etch mask 1522 may define a location of a grating ridge. In some embodiments, the slanted grating may be a two-dimensional grating and thus the pattern of etch masks 1522 may include a two-dimensional etch masks 1522.

FIG. 15C shows that, to etch a slanted grating, an ion beam 1530 may be incident on etch masks 1522 and grating material layer 1510 at a slant angle θ greater than 0° (e.g., 30° or larger) with respect to the surface normal of etch mask layer 1520 and grating material layer 1510. Ion beam 1530 may be generated and directed to etch masks 1522 and grating material layer 1510 as described above with respect to, for example, FIGS. 10-14. Slant angle θ of ion beam 1530 may be the same as the slant angle of the slanted grating to be etched. Due to the slant angle of the incident ion beam 1530 and the thickness of the etch masks 1522, a large portion of ion beam 1530 may be blocked by etch masks 1522 and may not reach grating material layer 1510.

FIG. 15D shows that, because a large portion of ion beam 1530 may be blocked by etch masks 1522, regions of grating material layer 1510 shadowed by etch masks 1522 may not be etched. As such, only a small portion of grating material layer 1510m may be etched to form grating grooves 1512, where the width of each grating groove may be a small portion of the grating period. Therefore, the etch grating may have a much larger duty cycle than the duty cycle of etch masks 1522. The shadowing effect of etch masks 1522 may become greater when the slant angle θ of ion beam 1530 increases and/or the height of etch masks 1522 increases. For example, an ion beam with a larger slant angle θ may cause the width of the grating ridges, and thus the duty cycle, of the slanted grating to be much larger than the line width (or the duty cycle) of etch masks 1522.

FIG. 15E shows that the shadowing effect of the etch masks may become greater when the height of the etch masks increases. When etch masks 1524 with a large height is used, ion beam 1530 with slant angle θ may all be blocked by etch masks 1524, and grating material layer 1510 may not be etched by ion beam 1530 to form a surface-relief grating in grating material layer 1510.

As shown in FIGS. 15A-15E, the thicker the etch mask layer and the larger the slant angle, the higher the shadowing effect and thus the higher the increase in the grating ridge width or duty cycle of the slanted grating. For example, the duty cycle of a slanted grating etched using a thick etch mask having a duty cycle of 0.1 may be 0.4 or higher. In some cases (e.g., when the grating period is large), reducing the lateral size (e.g., width) of etch mask 1522 may help to reduce the duty cycle of the slanted structure. However, as described above, the minimum feature size of a thick etch mask layer that can be reliably manufactured may be limited. Thus, reducing the feature size of the thick etch mask may not be sufficient to achieve a low duty cycle (or a small grating ridge width), a large slant angle, and/or a high grating depth.

According to certain embodiments, slanted ion implantation (e.g., H⁺ ion implantation), oxidation of the implanted region, and chemical etching processes (e.g., diluted HF etching) and/or dry etching processes (e.g., using reactive gas such as SF6) may be used to more accurately fabricate slanted structures with desired dimensions on various materials, including materials that may have a high refractive index. Ion implantation may be a process for introducing ions of one or more elements into a target material. In ion implantation, dopant atoms may be volatilized, ionized, accelerated, separated by the mass-to-charge ratios, and directed at the target material, such as a silicon substrate. The dopant atoms may enter the target material, collide with the host atoms, lose energy, and come to rest at a certain depth within the target material. The ion implantation may cause cascading effects of crystal damages. The average penetration depth may be determined by the dopant, the substrate material, the acceleration energy, and the ion incident angle with respect to the substrate and the crystallographic axes (e.g., channeling effects may occur when ions are incident along certain crystal axes). Ion implantation energies may range, for example, from about tens of electron volts (eVs) to about several hundred or about several million electron volts, resulting in ion distributions with average depths of, for example, from about <10 nm to about >10 μm. In one example, H⁺ ions with about tens of keVs may be used for H⁺ implantation, without causing damages (although the implant depth may be shallower). Each ion may include a single atom or molecule, and the total number (dose) of ions implanted in the target is the integration of the ion current over time. The dose and depth profile of ion implantation can be precisely controlled. In some embodiments, the ion implantation may be performed at low temperatures, and thus may use photoresist as mask. Other materials may also be used for the mask, such as oxide, poly-Si, metal, etc. In some embodiments, the ion implantation may be performed at high temperatures or followed by high temperature annealing.

Ion implantation may change the physical, chemical, optical, and/or electrical properties of the target material. For example, the ions penetrated into the target material can alter the elemental composition and/or electrical conductivity of the target material when the ions differ in composition from the target material. Implanting ions that are parts of the target material may also change the properties of the target material. For example, implanting Si into SiC may cause changes to the interstitial Si atoms, as well as the generation of other point defects from cascaded damages to the crystal structures (e.g. forcing C and/or Si atoms out of position). Ion implantation may cause chemical and/or physical changes in the target material when ions with a high energy or speed impinge on the target material. For example, the crystal structure of the target material may be changed or damaged by the energetic collision and the cascaded damages by secondary atoms resultant from the impact, where atoms displaced by the collision may have enough energy to displace other atoms out of position. Depending on the ion energy, the number of cascaded damage events may be amplified greatly. For example, a nitrogen atom at 100 eV, may only cause about 2 cascaded damage events, but a nitrogen atom at 1000 eV may cause more than 20 cascaded damage events. The damages may directly contribute to the optical loss (e.g., via absorption or scattering).

The ion implantation or ion beam etching equipment used for the ion implantation generally includes an ion source for generating ions of the desired element, an accelerator for electrostatically accelerating the ions to a high speed (and thus a high energy), and a target chamber where the ions may impinge on a target mounted on a supporting structure. In some implementations, some filtering may be performed to ensure the purity of the ion beam, such as rejecting isotopes and impurities within the precursor material. The supporting structure may move linearly, rotationally, or both, such that the implantation angle, area, dose, and time may be changed by controlling the movement of the supporting structure that holds the target. The supporting structure may also control the temperature of the target, such as cooling or heating the target.

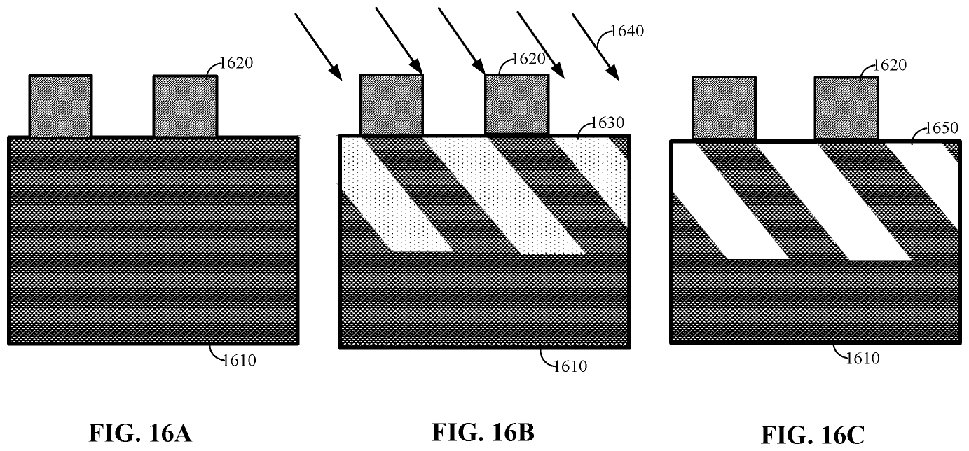

FIG. 16A illustrates an example of a substrate 1610 on which slanted structures may be formed using a mask 1620 according to certain embodiments. Substrate 1610 may include one or more types of dielectric materials, such as glass, quartz, plastic, polymer, poly(methyl methacrylate) (PMMA), crystal, SiN, SiC, ceramic, TiOₓ, LiNbO₃, HfOₓ. TiSiOₓ, ZnSe, InGaAs, GaP, ZnS, GGG, and the like. In some embodiments, the composition of the dielectric materials (e.g., layer stack-up) in substrate 1610 may be optimized to enable sufficient chemical and/or physical changes in substrate 1610. In some embodiments, substrate 1610 may include a semiconductor material, such as Si. In some embodiments, substrate 1610 may include a layer of material formed on a substrate, such as a Si₃N₄ or SiO₂ layer formed on a Si or other substrate. In some embodiments, substrate 1610 may include a silicon containing material (e.g., SiO₂, Si₃N₄, SiC, SiOₓN_{y}, or amorphous silicon), an organic material (e.g., spin on carbon (SOC) or amorphous carbon layer (ACL) or diamond like carbon (DLC)), or an inorganic metal oxide layer (e.g., TiOₓ, AlOₓ, TaOₓ, HfOₓ, etc.). Mask 1620 may include, for example, a photoresist material, a metal (e.g., copper, chrome, aluminum, or molybdenum), an intermetallic compound (e.g., MoSi₂), poly-silicon, or a polymer. The material used for mask 1620 and the thickness of mask 1620 may be selected based on the ions to be implanted. Mask 1620 may be thick enough such that ions may not penetrate through the mask and reach the substrate under the mask. In general, a mask with a lower thickness is desired in order to, for example, reduce scattering by the mask layer or not to block the ions from reaching the area to be implanted. A thinner mask may be used for lighter ions, such as H⁺ ions. Mask 1620 may include a pattern corresponding to the desired cross-sectional shape of the slanted structure, and may be formed by, for example, a lithography process.

FIG. 16B illustrates an example of a slanted ion implantation process according to certain embodiments. As shown in FIG. 16B, an ion beam 1640 may impinge on substrate 1610 at a certain angle. In some embodiments, this may be achieved by rotating the substrate supporting structure to a desired angle. Mask 1620 on substrate 1610 may block a portion of the ions in ion beam 1640 such that the portion of the ions would not reach substrate 1610. In areas that are not blocked or are only partially blocked by mask 1620, the ions may enter substrate 1610, collide with the atoms in the substrate, lose energy, and finally rest at a certain depth within substrate 1610. In some implementations, reactive chemistry may also be present due to the introduction of gas species near the substrate (e.g., from gas ring around the substrate) or other ions, molecules, and/or radicals within the ion beam. After the ion implantation, a plurality of implanted regions 1630 may be formed. The depth of implanted regions 1630 may depend on the penetration depth, which may be determined by the ion element, the substrate material, and the energy and incident angle of the ions. The total amount of ions implanted in each implanted region 1630 may depend on the ion current (flux), the ion energy, and the implantation time.

As described above, ion implantation may change the physical, chemical, or electrical properties of the target material. For example, a Si₃N₄ material layer may not be easily etched using, for example, diluted hydrofluoric acid (dHF), where the etch rate may be less than about 20 Å per minute at room temperature. When hydrogen ions are implanted into a Si₃N₄ material layer, the Si₃N₄ material layer may be modified according to:

Si₃N₄+H⁺→SiHₓN_{y},

where SiHₓN_{y} may be relatively easily etched by dHF compared with Si₃N₄. Thus, hydrogen ion implantation may change the etch rate of the Si₃N₄ material layer. The implanted regions may have a much higher etch rate using dHF than the regions without hydrogen ion implantation. Therefore, anisotropic etching of the Si₃N₄ material layer may be achieved after selective ion implantation. In some embodiments, O₂ may be added to a Si₃N₄ film to form a SiₓO_{y}N_{z} material. In some embodiments, hydrogen ions may be implanted into SiC substrate.

FIG. 16C illustrates an example of a slanted surface-relief structure 1650 formed on substrate 1610 after one or more ion implantation and wet etching processes according to certain embodiments. As shown in FIG. 16C, implanted regions 1630 shown in FIG. 16B may be etched away to form slanted grooves within substrate 1610. In some embodiments, annealing may be performed after the ion implantation to promote the reaction, and hence the index modification and/or etch rate adjustment. Various gases, such as reductive forming gas, steam annealing, oxidative chemistry, and the like, may be used in the annealing environment. The annealing step may help to cure some of the defects in the damaged crystal (sub-surface).

In some embodiments, the above described ion implantation process and wet etching process (e.g., using dHF or other etching solutions) may be performed repeatedly to form deep slanted structures in the substrate layer (e.g., Si₃N₄ material layer). The depth of the slanted structures may depend on the penetration depth of each ion implantation process. In this way, slanted structures with a high aspect ratio may be fabricated in a substrate. In some embodiments, the deep slanted structures can be achieved through simultaneous or sequential ion bombardment-based modification and modified layer removal with appropriate selection of feed gas mixture, ion source, and extraction parameters. The depth of the structures can be controlled by, for example, the etch time and some other parameters.

After slanted surface-relief structure 1650 is formed in substrate 1610, mask 1620 may be removed. In some embodiments, as described above, an overcoat layer may be formed on slanted surface-relief structure 1650 to fill the slanted grooves with a material having a refractive index different from the refractive index of substrate 1610.

In some embodiments, the ion implantation process described above with respect to FIG. 16B may be used to change the optical property of the target material, such as the real and/or complex refractive index of the target material. For example, a Si₃N₄ target layer may have a refractive index between 1.8 and 2.1 (e.g., 1.98). Ion implantation in the Si₃N₄ target layer (e.g., using oxygen ions) may change the implanted regions of the Si₃N₄ target layer into a second material (e.g., a silicon dioxide like material). The second material may have a refractive index different from the target material. In some embodiments, the refractive index of the second material may be lower than the refractive index of the target material. For example, the refractive index of the second material (e.g., SiO₂ like material) may be between 1.3 and 1.6, such as 1.46. Thus, a relatively high refractive index variation may be created within the target to form a Bragg-like grating. In some embodiments, depending on the ions used for the implantation, the refractive index of the second material may be higher than the refractive index of the target material.

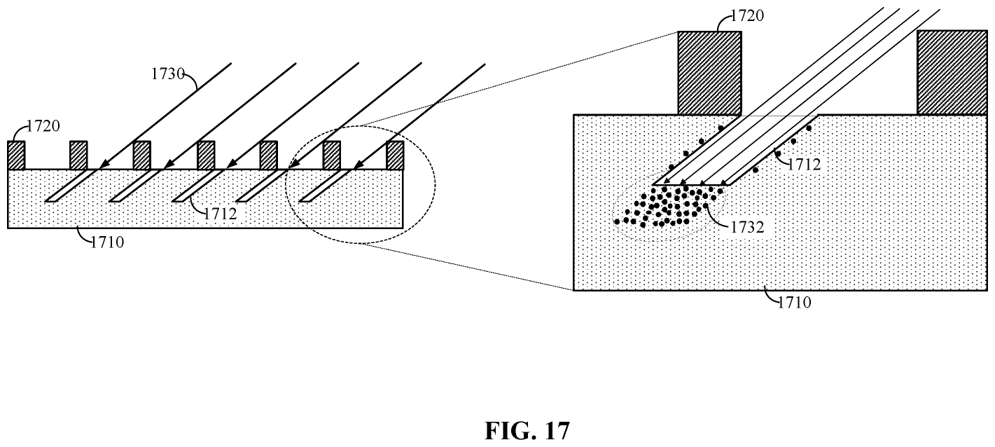

FIG. 17 shows that, after etching a grating material layer 1710 using etch masks 1720 and a slanted ion beam 1730, some ions 1732 may penetrate into the remaining grating material layer 1710, such as regions near surfaces of grating grooves 1712. These implanted ions 1732 may change certain physical and/or chemical properties of the grating materials, which may depend on the impurity type, concentration, implantation depth of the implanted ions, and whether high temperature annealing is performed to activate the implanted impurities. For example, the ion concentration and the implantation depth of the implanted regions may depend on the ion element/molecule/diatom and ion energy of the ion beam and properties of the grating materials. Thus, the ion implanted regions of the grating material layer may have modified physical properties, such as conductivity, optical loss, crystal phase and structure, effective refractive index, oxidation rate, and etch rate. Some of these changes in the local material properties are undesirable and can significantly degrade the performance of the slanted gratings. For example, due to the incorporation of implanted ions and changes (e.g., damages) to the crystalline structure, the refractive index of the implanted regions may be different from the refractive index of other regions of the grating material, and the optical loss of the grating material due to absorption from point and extended crystalline defects, scattering from extended crystalline defects, and/or Fresnel reflection may increase.

According to certain embodiments, the etch selectivity and other differences in the properties (e.g., oxidation rate) between the ion implanted regions (e.g., including hydrogen, oxygen, helium, or lithium ion) and the pristine regions of the grating material layer may be used to improve the etch depth and duty cycle by subsequent high-selectivity etching of the ion implanted regions from the grating material layer. This selective etching can be achieved in several ways, depending on the type and concentration of the implanted ions and their impact on the implanted regions of the grating material layer. In one example, ions may be intentionally implanted in the grating material layer to cause a phase change in the grating material layer, for example, from crystalline to amorphous, and then the subsequent etch process may be tailored to preferentially etch the amorphous phase region.

In another example, certain types of ions may be implanted with a certain density to increase the oxidation or reduction rate of the affected grating material region compared to the pristine regions. Thus, oxidation or reduction of the entire device may cause rapid, selective oxidation of the ion implanted regions compared to the pristine regions. The oxidized regions may have low absorption and/or may form a layer that passivates mid-gap electron states that otherwise may exist at the surface or sub-surface, due to crystal reconstruction or surface chemistry. Subsequent selective etching of the oxides may then result in more selective removal of the ion implanted regions. The etching of the ion implanted regions may be performed using ion beam etching, tailored wet etching processes, atomic layer etching, other plasma exposure (non-IBE), and/or high temperature annealing in appropriate gas chemistry. Techniques disclosed herein can achieve desired grating parameters, such as etch depth, slant angle, and duty cycle, while at the same time alleviating the undesirable properties of the ion implanted regions by removing the ion implanted regions.

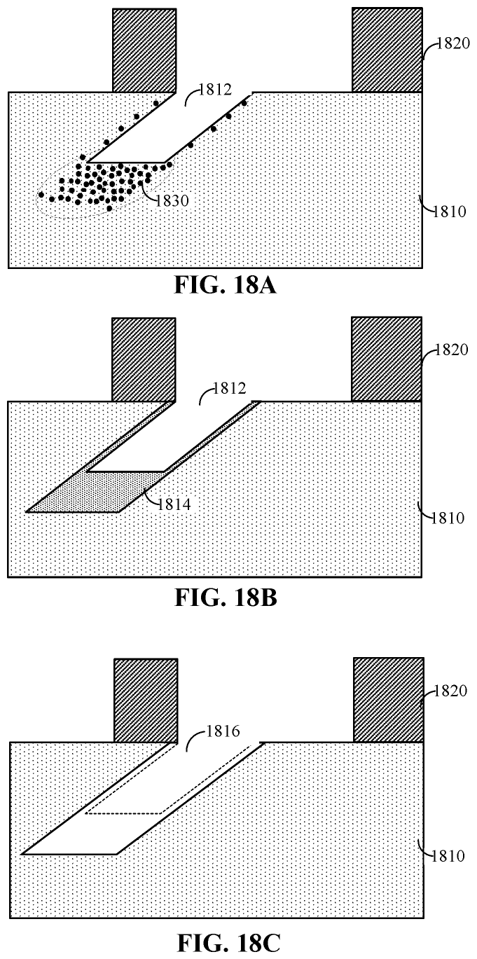

FIGS. 18A-18C illustrate an example of a process for etching a slanted grating with improved optical quality. In the example illustrated in FIG. 18A, a specific type of ions 1830 may be intentionally implanted with a certain density into a grating material layer 1810 using etch masks 1820, during an ion beam etching process (e.g., as described with respect to FIG. 17) or an ion beam implantation process (e.g., as described with respect to FIG. 16). Ions 1830 implanted into regions of grating material layer 1810 near surfaces of the etched grating grooves 1812 may increase the oxidation rate of the implanted regions compared to the pristine regions.

FIG. 18B shows that grating material layer 1810 may be oxidized in an oxidization environments, such as an oxidization chamber filled with oxidants. Oxidation of the grating material layer 1810 may cause rapid and selective oxidation of ion implanted regions 1814 compared to the pristine regions. Ion implanted regions 1814 may have a higher concentration of oxide, compared with the pristine regions. As described above, the oxidized regions may have low absorption and/or may form a layer that passivates the mid-gap electron states that may otherwise exist at the surface or sub-surface, due to crystal reconstruction or surface chemistry. In some embodiments, grating material layer 1810 may be reduced in an reductive environments, such as an reductive chamber filled with reducing chemistry.

FIG. 18C shows that grating material layer 1810 may be etched using a certain dry or wet etching process that may have a high etch selectivity between oxide and the grating material, such that ion implanted regions 1814 may be preferentially remove over other regions of grating material layer 1810 to form a deeper grating groove 1816. The etching of ion implanted regions 1814 may be performed using, for example, ion beam etching, atomic layer etching, or tailored wet etching processes. Processes described in FIGS. 18A-18C may be performed repeatedly, until a desired grating depth is achieved.

As described above, in some applications, it may be desirable that the slanted structures are not uniform across the substrate. For example, some grating structures may work for light in a certain wavelength range and/or within a certain field of view. For light of different wavelength and/or within a different field of view, different grating structures may be needed. Thus, in some implementations, the slanted structures may include different structures at different areas in order to more effectively interact with (e.g., diffract) light in a wide wavelength range and within a large field of view. For example, the slanted structures may have different periods, different slant angles, different depths, different duty cycles, different grating shapes, different refractive index variations, or any combination thereof, in different areas on the substrate. Techniques described above may be used to make such slanted structures as described in detail below.

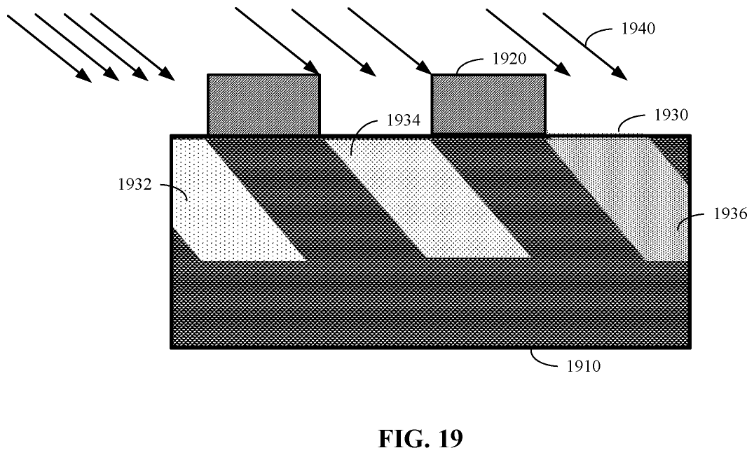

FIG. 19 illustrates an example of a process for fabricating a slanted structure 1930 with a variable refractive index in a substrate 1910 according to certain embodiments. As described above, the refractive index of the substrate may be changed by ion implantation. The amount of refractive index change may depend on the ions used and the dose of the ion implantation. By selectively applying an ion implantation (e.g., changing the dose of the ions) at different regions of substrate 1910 (e.g., a Si₃N₄ substrate) using an ion beam 1940 and a mask 1920 (and/or a shutter), slanted structure 1930 having the variable refractive index may be formed on substrate 1910. The dose of the ions implanted into a region of substrate 1910 may be controlled by controlling the ion current, ion energy, the implantation time, and/or ion beam incident angle with respect to the crystal and substrate plane. In some implementations, the implantation time may be controlled by a shutter or may be controlled by controlling the moving speed of the substrate supporting structure that holds the substrate. For example, as shown in FIG. 19, the dose of the ions (e.g., oxygen ions) implanted into region 1932 may be higher than the dose of the ions implanted into region 1934, and thus region 1932 may have a lower or higher refractive index than region 1934, which may be determined by the dependence of the refractive index on the ion type, and ion density, and the like. Similarly, the dose of the ions implanted into region 1934 may be higher than the dose of the ions implanted into region 1936, and thus region 1934 may have a lower or higher refractive index than region 1936, which may be determined by the dependence of the refractive index on the ion type, and ion density, and the like. Thus, slanted structure 1930 may have different refractive indexes and thus different diffractive performances (e.g., diffractive efficiencies) at regions 1932, 1934, and 1936. For example, modifying the refractive index may reduce the leakage of the display light to the ambient environment, thereby improving the privacy, efficiency, and user experience and reducing interference.

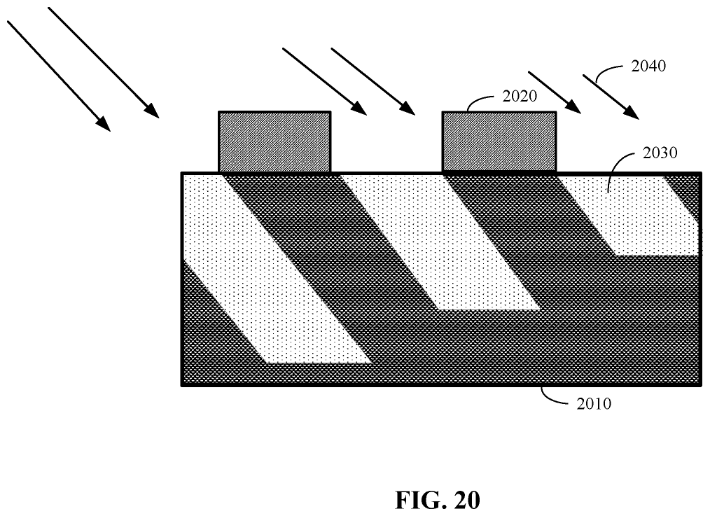

FIG. 20 illustrates an example of a process for fabricating a slanted structure with a variable depth in a substrate 2010 according to certain embodiments. As described above, the depth of the slanted structure may depend on the ion penetration depth, which may in turn depend on the ion element, the substrate material, and the energy of the ions. Thus, by varying the energy of the ions in an ion beam 2040 applied to different regions of substrate 2010 using a mask 2020, the penetration depths and thus the thicknesses of ion implanted regions 2030 may vary as shown in FIG. 20. Therefore, grating grooves having different depths may be formed in ion implanted regions 2030 of substrate 2010 after the selective oxidization and/or selective etching described above. In some implementations, the ion energy may be changed by changing the acceleration voltage of the accelerator in the ion implantation equipment or by changing the ion beam composition (e.g., relative percentage of specific type of ions).

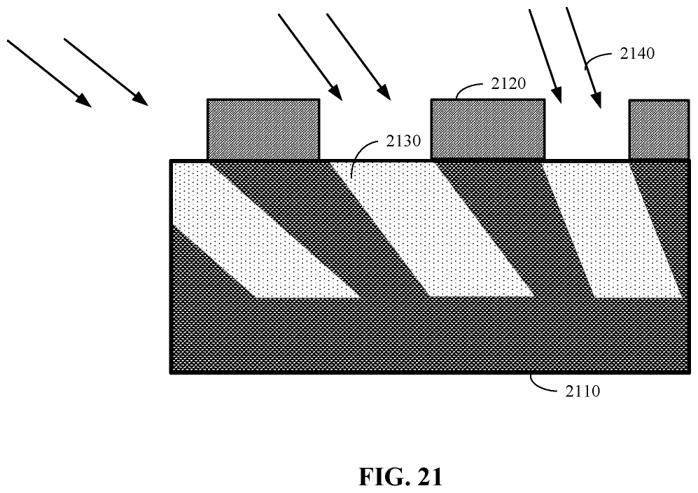

FIG. 21 illustrates an example of a process for fabricating a slanted structure with a variable slant angle in a substrate 2110 using etch masks 2120 according to certain embodiments. The slant angle of the slanted structure may be changed by changing the angle of an ion beam 2140 with respect to the surface normal of substrate 2110, such that the slanted angles of ion implanted regions 2130 may vary as shown in FIG. 21. Therefore, grating grooves having different depths may be formed in ion implanted regions 2130 of substrate 2110 after the selective oxidization and/or selective etching described above. In some implementations, the angle of ion beam 2140 with respect to the surface normal of substrate 2110 may be changed by changing a rotation angle of a substrate supporting structure in the ion implantation equipment or by changing the angle of the ion beam.

The techniques described above with respect to FIGS. 19-21 may be used individually or in any combination to fabricate straight surface-relief structures or slanted structures with a varying slant angle, depth, refractive index, and/or grating profile in a substrate. For example, in some embodiments, different regions of the substrate may be implanted at different angles with ions having different energies to form implanted regions with different slant angles and depths. Due to the etch rate difference between the substrate and implanted regions, a slanted surface-relief structure with a varying slant angle and depth may be formed in the substrate. When an overcoat layer is formed on the slanted surface-relief structures using, for example, atomic layer deposition (ALD), the over-coated material filled in the gaps in the surface-relief structure may have a varying slant angle and depth across the substrate. The post-implant oxidation and/or reduction may improve the adhesion of the overcoat layer and the atomic layer deposition, and/or may be used as the mask for area-selective atomic layer deposition, such that the overcoat layer would avoid overburden (material on top of the grating ridges). For example, the ion implantation may be performed vertically or along the slant angle of the grating ridges, to implant ions at the top surfaces of the grating ridges, and then the oxidation process may oxidize the top surfaces of the grating ridges to form an oxide layer that may then be used as the mask layer for ALD such that the overcoat layer formed by the ALD may not be formed on the top surfaces of the grating ridges. In some implementations, the above described techniques may also be used to modify the refractive index of at least some regions of the overcoat layer. In some implementations, the above described techniques may also be applied to the overcoat layer to form a structure with a varying slant angle, depth, or refractive index in the overcoat layer. For example, techniques disclosed herein may also be used for selective etching of the top layer of overcoat/ALD material, where the depth of the etching may be controlled by, for example, ion energy, dose, type, and the like.

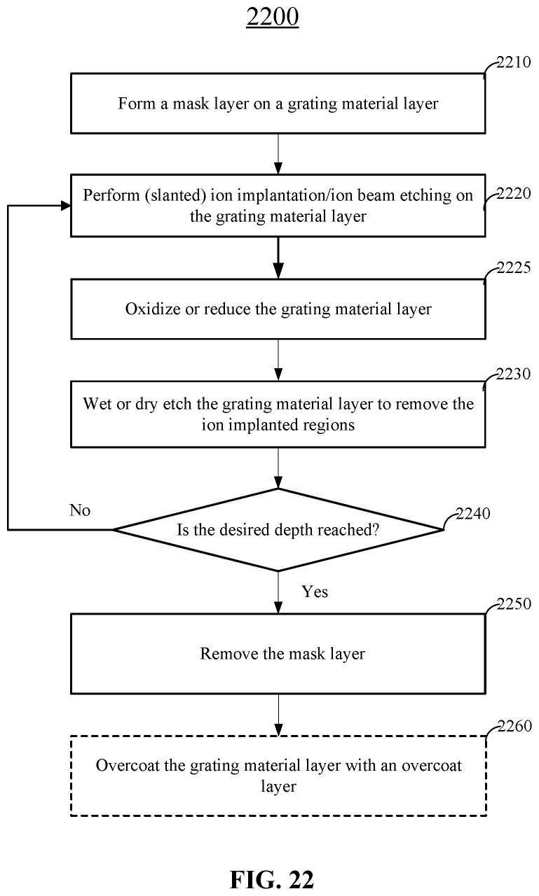

FIG. 22 is a simplified flowchart 2200 illustrating an example of a method of fabricating a surface-relief structure (e.g., a straight surface-relief grating or slanted surface-relief grating) according to certain embodiments. The operations described in flowchart 2200 are for illustration purposes only and are not intended to be limiting. In various implementations, modifications may be made to flowchart 2200 to add additional operations or to omit some operations. The operations described in flowchart 2200 may be performed using, for example, ion implantation equipment and/or wet etching equipment.

At block 2210, a mask layer may be formed on a grating material layer. The grating material layer may include one or more types of dielectric materials, such as glass, quartz, plastic, polymer, PMMA, crystal, or ceramic. In some embodiments, the grating material layer may include a semiconductor material, such as Si. In some embodiments, the grating material layer may include a silicon containing material (e.g., SiO₂, Si₃N₄, SiC, SiOₓN_{y}, or amorphous silicon), an organic material (e.g., spin on carbon (SOC) or amorphous carbon layer (ACL) or diamond like carbon (DLC)), an inorganic metal oxide layer (e.g., TiOₓ, AlOₓ, TaOₓ, HfOₓ, etc.), glass, ZnS, GGG, LiNbO₃, and the like. The mask layer may include, for example, a photoresist material, a metal (e.g., copper, chrome, aluminum, or molybdenum), an intermetallic compound (e.g., MoSi₂), poly-silicon, or a polymer. The material used for the mask layer and the thickness of the mask layer may be selected based on the ions to be implanted. For example, a thinner mask layer may be used for lighter ions, such as ft ions. The mask layer may be thick enough such that ions may not penetrate through the mask and reach the grating material layer under the mask. The mask layer may include a pattern corresponding to the desired cross-sectional shape of the surface-relief structure, and may be formed by, for example, a lithography process. In some embodiments, the mask layer may include slits that may diffract the incident ion beam.

At block 2220, the grating material layer may be implanted and/or etched with an ion beam at a slant angle equal to or greater than 0° using the mask layer. The slant angle may be measured with respect to a surface normal of the grating material layer. In some embodiments, the slant angle may be greater than 30°, 45°, 50°, 70°, or larger. In some implementations, the slant angle may be controlled by rotating the grating material layer with respect to the ion beam using, for example, a rotatable supporting structure that can hold the grating material layer. The mask layer on the grating material layer may block a portion of the ions in the ion beam such that the portion of the ions would not reach the grating material layer. In areas that are not blocked or only partially blocked by the mask layer, the ions may enter the grating material layer, collide with the atoms in the grating material layer, and rest at some depth within the grating material layer. In some embodiments, the ion beam may be diffracted by the mask layer. After the ion implantation, a plurality of implanted regions may be formed in the grating material layer. The depth of the implanted regions may depend on the penetration depth, which may depend on the ion element, the substrate material, the energy of the ions, the incident angle of the ion beam, and the like. The total amount of ions implanted in each implanted region may depend on the ion current (flux) and the implantation time. In some embodiments, the ions in the ion beam may include hydrogen ions, oxygen ions, helium ions, lithium ions, or a combination thereof. In some embodiments, during the implanting, the grating material layer may be rotated to vary the slant angle for the plurality of implanted regions across the surface-relief structure. In some embodiments, during the implanting, the ion energy of the ions in the ion beam may be adjusted to change the depth of the plurality of implanted regions across the surface-relief structure. In some embodiments, during the implanting, different amounts and/or types of ions may be implanted into different regions of the plurality of implanted regions by using different ion currents for the ion beam, different implantation time, or both. As described above, implanting ions into the grating material layer may change certain physical and chemical properties of the implanted regions, such as changing the implanted regions from the crystalline phase to the amorphous phase, such that the implanted regions may have a different refractive index, etch rate, and/or oxidation rate, compared with the pristine regions of the grating material layer.

In some embodiments, at block 2225, the grating material layer may be oxidized (or reduced), for example, in an oxygen environment (or a reductive environment) at an elevated temperature. The ion implantation may cause the ion implanted regions of the grating material layer to have a higher oxidization rate than un-implanted region of the grating material layer. The oxidized (or reduced) regions may have higher etch rates than unoxidized (or unreduced) regions using certain etching techniques, such as some wet or dry chemical etching processes or atomic layer etching processes. In some embodiments, the oxidation process and reduction process may be performed alternately in multiple processing cycles.

At block 2230, the grating material layer may be wet-etched or dry etched to remove materials in the implanted regions to form the surface-relief structure. As described above, implanting ions into the grating material layer and/or selectively oxidizing the implanted regions may change the etch rate of the implanted regions. For example, implanting hydrogen ions into a Si₃N₄ material layer may significantly increase the etch rate of the implanted regions using diluted HF relative to the etch rate of the regions of the grating material layer that are not implanted with hydrogen ions. Thus, wet etching the selectively implanted grating material layer using diluted HF can be highly anisotropic, and may remove materials in the implanted regions while keeping the materials in the regions that are nor ion-implanted. In another example, the implanted region may have a higher centration of oxide, and may be more preferentially etched by an etching process that has a high etch rate for oxide. Thus, a surface-relief structure may be formed. The slant angle of the surface-relief structure may correspond to the slant angle of the ion implantation, and the depth of the surface-relief structure may depend on the ion energy of the ions in the ion beam as described above.

At block 2240, if the desired depth of the surface-relief structure is reached, the process may proceed to operations at block 2250. If the desired depth of the surface-relief structure has not been reached, the process may proceed to operations at block 2220. For example, in some embodiments, it may be desirable that the depth of the surface-relief structure is greater than 200 nm, 500 nm, 1 um, or 2 um. Thus, a single cycle of ion implantation, oxidization, and dry/wet etching processes may not be able to achieve the desired depth due to, for example, the limitation of the achievable ion energy of the ions for the implantation and/or the limitation of the thickness of the mask layer that can block ions with a high ion energy. Therefore, in some implementations, multiple cycles of the operations at blocks 2220 and 2230 may be performed to etch a portion of the grating material layer in each cycle, such that the desired depth may be achieved after the multiple cycles of ion implantation and wet etching. In some embodiments, multiple cycles of atomic layer etching may be used to etch the grating material to form the surface-relief grating.

At block 2250, the mask layer may be removed. As described above, techniques such as plasma or wet etching may be used to strip the mask layer with appropriate chemistry.

Optionally, at block 2260, the grating material layer with the surface-relief structure may be coated with a material having a refractive index different from the refractive index of the grating material layer. For example, in some embodiments, a high refractive index material, such as Hafnia, Titania, Tungsten oxide, Zirconium oxide, Gallium sulfide, Gallium nitride, Gallium phosphide, silicon, or a high refractive index polymer, may be used to coat the surface-relief grating and/or fill the gaps in the surface-relief structure. In some embodiments, a low refractive index material, such as silicon oxide, magnesium fluoride, porous silica, or fluorinated low index monomer (or polymer), may be used to coat the surface-relief structure and/or fill the gaps in the surface-relief structure. As a result, the surface-relief grating may have subwavelength grating period(s) (less than about 700 nm, 600 nm, 500 nm, 400 nm, 300 nm, 200 nm, or smaller) for visible light, large slant angle(s) (e.g., greater than 30°, 45°, 60°, or larger), high grating depth(s) (e.g., greater than 100 nm, such as 200 nm, 300 nm, 400 nm, 500 nm, 1 μm, or higher), smaller duty cycle(s) (e.g., less than about 40%, 30%, 20%, or 10%), and a high refractive index contrast (e.g., greater than about 0.1, 0.2, 0.3, 0.4, 0.5, 0.6, 0.7, 0.8, 0.9, 1.0, or higher).

In some embodiments, techniques disclosed herein may be used to form, in semiconductor epitaxial layers (e.g., including III-V semiconductor materials such as GaN, InGaN, GaP, InGaP, AlGaInP, or a combination), micro-LED mesa structures with low defect density near the mesa sidewall surfaces, or to treat the damaged sidewall surfaces of micro-LED mesa structures formed by, for example, dry etching. Reducing the defect density near the mesa sidewall surfaces may reduce the non-radiative recombination of the injected carriers diffused to regions near the mesa sidewall surfaces, thereby improving the internal quantum efficiency (IQE) of small micro-LEDs, in particular, AlGaInP-based red light-emitting micro-LEDs with small mesa sizes (e.g., less than about 10 μm, less than about 5 μm, less than about 3 μm, or less than about 2 μm).

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

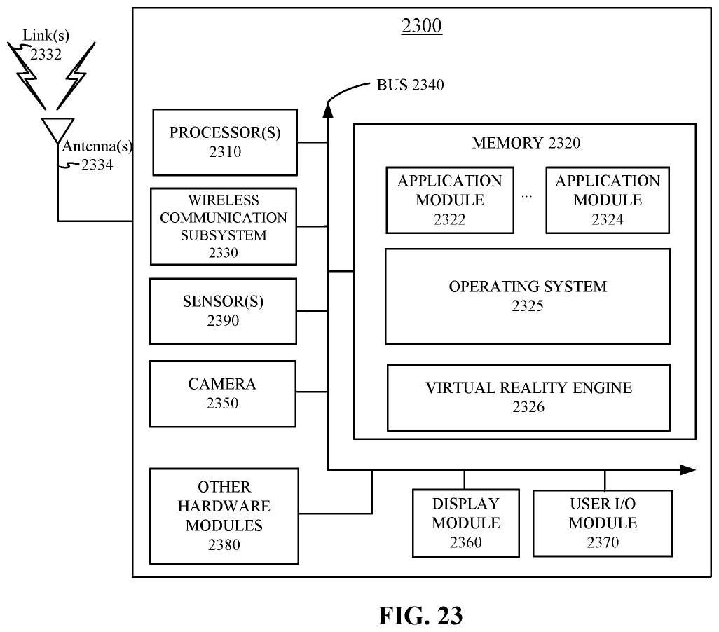

FIG. 23 is a simplified block diagram of an electronic system 2300 of an example of a near-eye display (e.g., HMD device) for implementing some of the examples disclosed herein. Electronic system 2300 may be used as the electronic system of an HMD device or other near-eye displays described above. In this example, electronic system 2300 may include one or more processor(s) 2310 and a memory 2320. Processor(s) 2310 may be configured to execute instructions for performing operations at a number of components, and can be, for example, a general-purpose processor or microprocessor suitable for implementation within a portable electronic device. Processor(s) 2310 may be communicatively coupled with a plurality of components within electronic system 2300. To realize this communicative coupling, processor(s) 2310 may communicate with the other illustrated components across a bus 2340. Bus 2340 may be any subsystem adapted to transfer data within electronic system 2300. Bus 2340 may include a plurality of computer buses and additional circuitry to transfer data.

Memory 2320 may be coupled to processor(s) 2310. In some embodiments, memory 2320 may offer both short-term and long-term storage and may be divided into several units. Memory 2320 may be volatile, such as static random access memory (SRAM) and/or dynamic random access memory (DRAM) and/or non-volatile, such as read-only memory (ROM), flash memory, and the like. Furthermore, memory 2320 may include removable storage devices, such as secure digital (SD) cards. Memory 2320 may provide storage of computer-readable instructions, data structures, program modules, and other data for electronic system 2300. In some embodiments, memory 2320 may be distributed into different hardware modules. A set of instructions and/or code might be stored on memory 2320. The instructions might take the form of executable code that may be executable by electronic system 2300, and/or might take the form of source and/or installable code, which, upon compilation and/or installation on electronic system 2300 (e.g., using any of a variety of generally available compilers, installation programs, compression/decompression utilities, etc.), may take the form of executable code.

In some embodiments, memory 2320 may store a plurality of application modules 2322 through 2324, which may include any number of applications. Examples of applications may include gaming applications, conferencing applications, video playback applications, or other suitable applications. The applications may include a depth sensing function or eye tracking function. Application modules 2322-2324 may include particular instructions to be executed by processor(s) 2310. In some embodiments, certain applications or parts of application modules 2322-2324 may be executable by other hardware modules 2380. In certain embodiments, memory 2320 may additionally include secure memory, which may include additional security controls to prevent copying or other unauthorized access to secure information.

In some embodiments, memory 2320 may include an operating system 2325 loaded therein. Operating system 2325 may be operable to initiate the execution of the instructions provided by application modules 2322-2324 and/or manage other hardware modules 2380 as well as interfaces with a wireless communication subsystem 2330 which may include one or more wireless transceivers. Operating system 2325 may be adapted to perform other operations across the components of electronic system 2300 including threading, resource management, data storage control and other similar functionality.

Wireless communication subsystem 2330 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2300 may include one or more antennas 2334 for wireless communication as part of wireless communication subsystem 2330 or as a separate component coupled to any portion of the system. Depending on desired functionality, wireless communication subsystem 2330 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 2330 may permit data to be exchanged with a network, other computer systems, and/or any other devices described herein. Wireless communication subsystem 2330 may include a means for transmitting or receiving data, such as identifiers of HMD devices, position data, a geographic map, a heat map, photos, or videos, using antenna(s) 2334 and wireless link(s) 2332. Wireless communication subsystem 2330, processor(s) 2310, and memory 2320 may together comprise at least a part of one or more of a means for performing some functions disclosed herein.

Embodiments of electronic system 2300 may also include one or more sensors 2390. Sensor(s) 2390 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 2390 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 2300 may include a display module 2360. Display module 2360 may be a near-eye display, and may graphically present information, such as images, videos, and various instructions, from electronic system 2300 to a user. Such information may be derived from one or more application modules 2322-2324, virtual reality engine 2326, one or more other hardware modules 2380, a combination thereof, or any other suitable means for resolving graphical content for the user (e.g., by operating system 2325). Display module 2360 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 2300 may include a user input/output module 2370. User input/output module 2370 may allow a user to send action requests to electronic system 2300. An action request may be a request to perform a particular action. For example, an action request may be to start or end an application or to perform a particular action within the application. User input/output module 2370 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2300. In some embodiments, user input/output module 2370 may provide haptic feedback to the user in accordance with instructions received from electronic system 2300. For example, the haptic feedback may be provided when an action request is received or has been performed.

Electronic system 2300 may include a camera 2350 that may be used to take photos or videos of a user, for example, for tracking the user's eye position. Camera 2350 may also be used to take photos or videos of the environment, for example, for VR, AR, or MR applications. Camera 2350 may include, for example, a complementary metal-oxide-semiconductor (CMOS) image sensor with a few millions or tens of millions of pixels. In some implementations, camera 2350 may include two or more cameras that may be used to capture 3-D images.

In some embodiments, electronic system 2300 may include a plurality of other hardware modules 2380. Each of other hardware modules 2380 may be a physical module within electronic system 2300. While each of other hardware modules 2380 may be permanently configured as a structure, some of other hardware modules 2380 may be temporarily configured to perform specific functions or temporarily activated. Examples of other hardware modules 2380 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 2380 may be implemented in software.

In some embodiments, memory 2320 of electronic system 2300 may also store a virtual reality engine 2326. Virtual reality engine 2326 may execute applications within electronic system 2300 and receive position information, acceleration information, velocity information, predicted future positions, or some combination thereof of the HMD device from the various sensors. In some embodiments, the information received by virtual reality engine 2326 may be used for producing a signal (e.g., display instructions) to display module 2360. For example, if the received information indicates that the user has looked to the left, virtual reality engine 2326 may generate content for the HMD device that mirrors the user's movement in a virtual environment. Additionally, virtual reality engine 2326 may perform an action within an application in response to an action request received from user input/output module 2370 and provide feedback to the user. The provided feedback may be visual, audible, or haptic feedback. In some implementations, processor(s) 2310 may include one or more GPUs that may execute virtual reality engine 2326.

In various implementations, the above-described hardware and modules may be implemented on a single device or on multiple devices that can communicate with one another using wired or wireless connections. For example, in some implementations, some components or modules, such as GPUs, virtual reality engine 2326, and applications (e.g., tracking application), may be implemented on a console separate from the head-mounted display device. In some implementations, one console may be connected to or support more than one HMD.

In alternative configurations, different and/or additional components may be included in electronic system 2300. Similarly, functionality of one or more of the components can be distributed among the components in a manner different from the manner described above. For example, in some embodiments, electronic system 2300 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each flow diagram may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method of fabricating a surface-relief structure in a material layer, the method comprising:
forming a mask layer on the material layer;
implanting ions into a plurality of regions of the material layer using the mask layer and an ion beam at a slant angle equal to or greater than 0°, wherein the slant angle is measured with respect to a surface normal direction of the material layer, and wherein implanting the ions into the plurality of regions of the material layer increases an oxidation rate or a reduction rate of the plurality of regions of the material layer;
selectively oxidizing or reducing the plurality of regions of the material layer that includes implanted ions; and
selectively etching oxidized or reduced materials in the plurality of regions of the material layer to form the surface-relief structure in the material layer and reduce optical loss of the surface-relief structure caused by implanting the ions into the plurality of regions of the material layer.

2. The method of claim 1, further comprising performing the implanting, the selectively oxidizing, and the selectively etching repeatedly until a predetermined depth of the surface-relief structure is reached.

3. The method of claim 2, wherein the predetermined depth of the surface-relief structure is greater than 200 nm.

4. The method of claim 3, wherein the predetermined depth of the surface-relief structure is greater than 500 nm.

5. The method of claim 1, further comprising etching the material layer using the ion beam while implanting the ions into the plurality of regions of the material layer using the ion beam.

6. The method of claim 1, wherein the slant angle is greater than 30°.

7. The method of claim 1, wherein selectively oxidizing or reducing the plurality of regions of the material layer includes implanted ions comprises performing oxidation and reduction alternately.

8. The method of claim 1, wherein implanting the ions into the plurality of regions of the material layer comprises etching the material layer using the ion beam.

9. The method of claim 1, wherein selectively etching the oxidized or reduced materials in the plurality of regions of the material layer includes a dry etching or wet etching process that has a higher etch rate for the oxide materials in the plurality of regions of the material layer than for materials in other regions of the material layer.

10. The method of claim 1, wherein implanting the ions into the plurality of regions of the material layer comprises rotating the material layer or the ion beam during the implanting to vary the slant angle of the ion beam with respect to the plurality of regions of the material layer.

11. The method of claim 1, wherein implanting the ions into the plurality of regions of the material layer comprises changing energy of the ions during the implanting to change an implantation depth in the plurality of regions of the material layer.

12. The method of claim 1, wherein implanting the ions into the plurality of regions of the material layer comprises implanting different amounts of ions into different regions of the plurality of regions using different ion currents for the ion beam, different implantation times, or both.

13. The method of claim 1, wherein the ions comprise hydrogen ions, oxygen ions, helium ions, lithium ions, or a combination thereof.

14. The method of claim 1, wherein the material layer comprises SiN, SiC, TiO₂, Al₂O₃, SiOₓN_{y}, LiNbO₃, HfOₓ. TiSiOₓ, TaOₓ, ZnSe, InGaAs, GaN, GaP, ZnS, gadolinium gallium garnet, spin on carbon, amorphous carbon, or diamond like carbon.

15. The method of claim 1, further comprising:
removing the mask layer; and
forming an overcoat layer on the surface-relief structure in the material layer.

16. The method of claim 15, wherein forming the overcoat layer comprises:
implanting ions at top surfaces of the surface-relief structure;
oxidizing the surface-relief structure to form a deposition mask layer at the top surfaces of the surface-relief structure; and
depositing the overcoating layer in grooves of the surface-relief structure using atomic layer deposition and the deposition mask layer.

17. The method of claim 1, wherein implanting the ions into the plurality of regions of the material layer causes a phase of the plurality of regions of the material layer to change to an amorphous phase.

18. The method of claim 1, wherein the surface-relief structure includes a slanted surface-relief grating characterized by a grating period less than 1 μm and a duty cycle less than 30%.

19. The method of claim 1, wherein the surface-relief structure includes a slanted surface-relief grating characterized by a width of a grating ridge less than 100 nm.

20. The method of claim 1, wherein the mask layer includes a photoresist, a metal, an intermetallic compound, poly-silicon, or a polymer.
